(19) United States
(12) Patent Application Publication
(10) Pub. No.: US 2025/0256505 A1
(43) Pub. Date: Aug. 14, 2025

(54) LIQUID EJECTING APPARATUS AND CONTROL METHOD FOR LIQUID EJECTING APPARATUS

(71) Applicant: SEIKO EPSON CORPORATION, Tokyo (JP)

(72) Inventors: Akira MIYAGISHI, SHIOJIRI-SHI (JP); Hiroaki OKUI, AZUMINO-SHI (JP); Nobuaki ITO, SUWA-SHI (JP)

(21) Appl. No.: 19/050,298

(22) Filed: Feb. 11, 2025

(30) Foreign Application Priority Data
Feb. 14, 2024 (JP) 2024-020153

(51) Int. Cl. B41J 2/045; B41J 2/14

(52) U.S. Cl. CPC B41J 2/04588; B41J 2/04581; B41J 2/14233

(57) ABSTRACT

A liquid ejecting apparatus includes a liquid ejecting head that includes a nozzle which ejects an ink, a piezoelectric element which corresponds to the nozzle, a diaphragm which vibrates by driving the piezoelectric element, and a detection circuit which detects residual vibration of the diaphragm caused by driving the piezoelectric element, and an evaluation control portion which executes first evaluation for evaluating an ejection stability of the ink from the nozzle, in which in the first evaluation, the evaluation control portion causes the detection circuit to detect the residual vibration caused by continuously executing ejection driving of driving the piezoelectric element with a drive signal for ejecting the ink from the nozzle as first residual vibration, and evaluates the ejection stability of the ink from the nozzle based on the first residual vibration detected by the detection circuit.

The present application is based on, and claims priority from JP Application Serial Number 2024-020153, filed Feb. 14, 2024, the disclosure of which is hereby incorporated by reference herein in its entirety.

### BACKGROUND

### 1. Technical Field

The present disclosure relates to a liquid ejecting apparatus and a control method for the liquid ejecting apparatus.

### 2. Related Art

A liquid ejecting apparatus that prints an image by causing a nozzle to eject a liquid such as an ink by using a piezoelectric element is known. For example, the liquid ejecting apparatus includes a liquid ejecting head that causes the nozzle to eject the liquid with which a pressure chamber is filled, by vibrating a diaphragm that constitutes a part of the pressure chamber by the piezoelectric element. In this type of liquid ejecting apparatus, as a method of evaluating the liquid ejecting head, a method of detecting an ejection defect of the nozzle is proposed. For example, JP-A-2021-172053 discloses an ejection image analysis apparatus that analyzes a plurality of ejection images obtained by capturing a flight state of a liquid droplet ejected from a nozzle of a liquid droplet ejecting apparatus at a certain timing.

Meanwhile, in the method of analyzing the plurality of ejection images obtained by capturing the flight state of the liquid droplet ejected from the nozzle at the certain timing, it is necessary to prepare an imaging environment or the like to set an evaluation environment for detecting an ejection defect of the nozzle. Therefore, in the method of analyzing the plurality of ejection images, a load for setting the evaluation environment is large.

In addition, as a method for detecting an ejection defect of a nozzle without requiring an external element such as the imaging environment, for example, a method is known in which residual vibration generated in a diaphragm is detected after driving a piezoelectric element, and the ejection defect such as thickening of a liquid and non-ejection is detected based on the detected residual vibration. In the method using the residual vibration, it is not necessary to prepare a special evaluation environment, and thus an increase in load for detecting the ejection defect of the nozzle is prevented.

Here, in a liquid ejecting apparatus, it is desired that a waveform of a drive signal for driving the piezoelectric element is determined such that the ejection of the liquid from the nozzle is stable. Therefore, in evaluation of the liquid ejecting head, it is considered that evaluation for an ejection stability is performed, instead of the ejection defect detection described above or in addition to the ejection defect detection. Therefore, it is desired that the evaluation for the ejection stability of the liquid from the nozzle and the determination of the waveform of the drive signal for driving the piezoelectric element can be appropriately and easily performed without requiring the external element such as the imaging environment. In particular, it is desired to appropriately and easily evaluate the ejection stability of the liquid from the nozzle without requiring the external element such as the imaging environment.

### SUMMARY

According to an aspect of the present disclosure, there is provided a liquid ejecting apparatus including: a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element; and a control portion that executes first evaluation for evaluating an ejection stability of the liquid from the nozzle, in which in the first evaluation, the control portion causes the detection portion to detect the residual vibration caused by continuously executing ejection driving of driving the piezoelectric element with a drive signal for ejecting the liquid from the nozzle as first residual vibration, and evaluates the ejection stability of the liquid from the nozzle based on the first residual vibration detected by the detection portion.

In addition, according to another aspect of the present disclosure, there is provided a liquid ejecting apparatus including: a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element; and a control portion, in which the control portion causes the detection portion to detect the residual vibration caused by repeating ejection driving of driving the piezoelectric element a plurality of times with a drive signal for ejecting the liquid from the nozzle as first residual vibration, and determines a waveform of the drive signal based on the first residual vibration detected by the detection portion.

In addition, according to still another aspect of the present disclosure, there is provided a control method for a liquid ejecting apparatus including a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element, the method including: causing the detection portion to detect the residual vibration caused by repeating ejection driving of driving the piezoelectric element a plurality of times with a drive signal for ejecting the liquid from the nozzle as first residual vibration; and evaluating an ejection stability of the liquid from the nozzle based on the first residual vibration detected by the detection portion.

### BRIEF DESCRIPTION OF THE DRAWINGS

FIG. 1 is a block diagram illustrating an example of a configuration of a liquid ejecting apparatus according to an embodiment of the present disclosure.

FIG. 2 is a configuration diagram schematically illustrating the liquid ejecting apparatus.

FIG. 3 is an exploded perspective view of a liquid ejecting head.

FIG. 4 is a cross-sectional diagram taken along a line IV-IV in FIG. 3.

FIG. 5 is a block diagram illustrating an example of a configuration of the liquid ejecting head.

FIG. 6 is a timing chart illustrating an example of an operation of the liquid ejecting apparatus in a unit period.

FIG. 7 is a diagram illustrating an example of a waveform of a residual vibration signal.

FIG. 8 is a flowchart illustrating an example of an operation of the liquid ejecting apparatus when evaluating an ejection stability of an ink from a nozzle.

FIG. 9 is a flowchart illustrating an example of evaluating the stability illustrated in FIG. 8.

FIG. 10 is a block diagram illustrating an example of a configuration of a liquid ejecting head according to a first modification example.

FIG. 11 is a timing chart illustrating an example of an operation of the liquid ejecting apparatus according to the first modification example.

FIG. 12 is a flowchart illustrating an example of an operation of a liquid ejecting apparatus according to a second modification example.

### DESCRIPTION OF EMBODIMENTS

Hereinafter, embodiments for carrying out the present disclosure will be described with reference to the drawings. Meanwhile, in each drawing, the size and scale of each portion are appropriately different from the actual ones. The embodiments described below are preferred specific examples of the present disclosure and are thus added with technically preferred various limitations, but the scope of the present disclosure is not limited to such embodiments unless description for limiting the present disclosure is made in the following description.

### 1. Embodiment

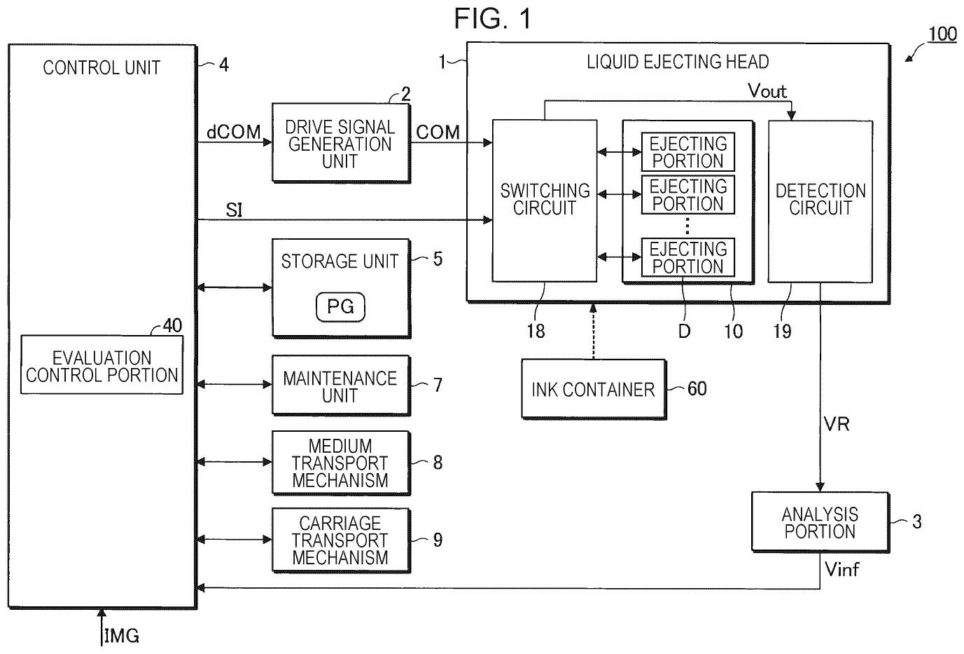

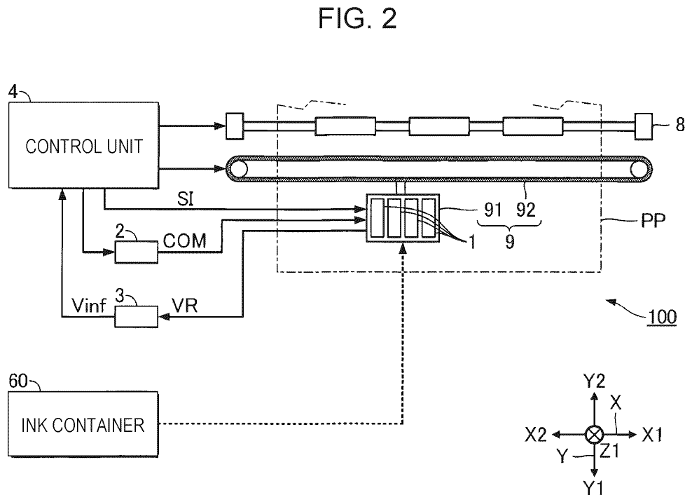

First, an outline of a liquid ejecting apparatus 100 according to the present embodiment will be described with reference to FIG. 1. In the present embodiment, it is assumed that the liquid ejecting apparatus 100 is an ink jet printer that ejects an ink to a medium PP to form an image, as an example. In the present embodiment, a recording paper illustrated in FIG. 2 to be described below is assumed as the medium PP. The ink is an example of a “liquid”.

FIG. 1 is a block diagram illustrating an example of a configuration of the liquid ejecting apparatus 100 according to an embodiment of the present disclosure.

For example, print data IMG indicating an image to be formed by the liquid ejecting apparatus 100 is supplied to the liquid ejecting apparatus 100 from a host computer such as a personal computer or a digital camera. The liquid ejecting apparatus 100 executes a printing process of forming the image indicated by the print data IMG supplied from the host computer on the medium PP.

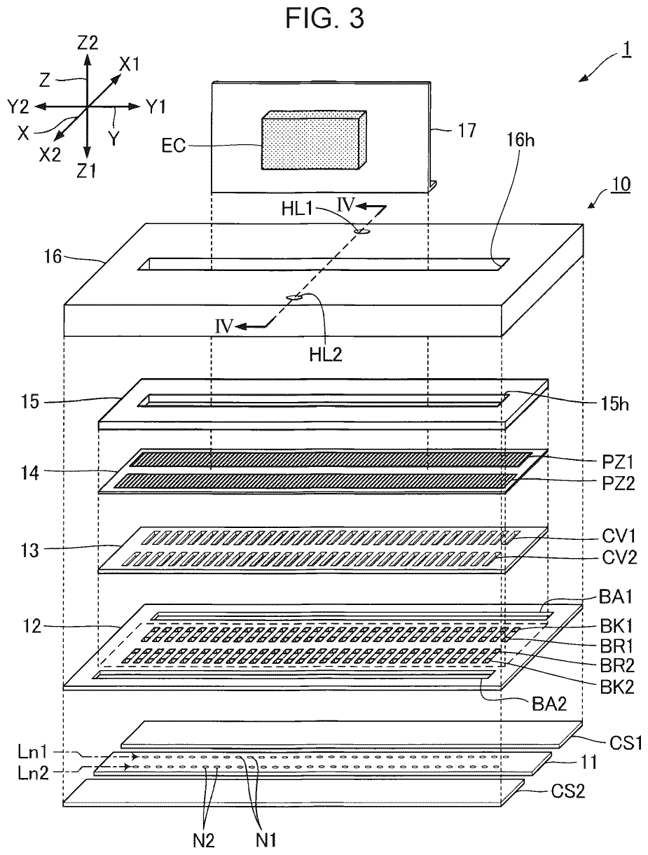

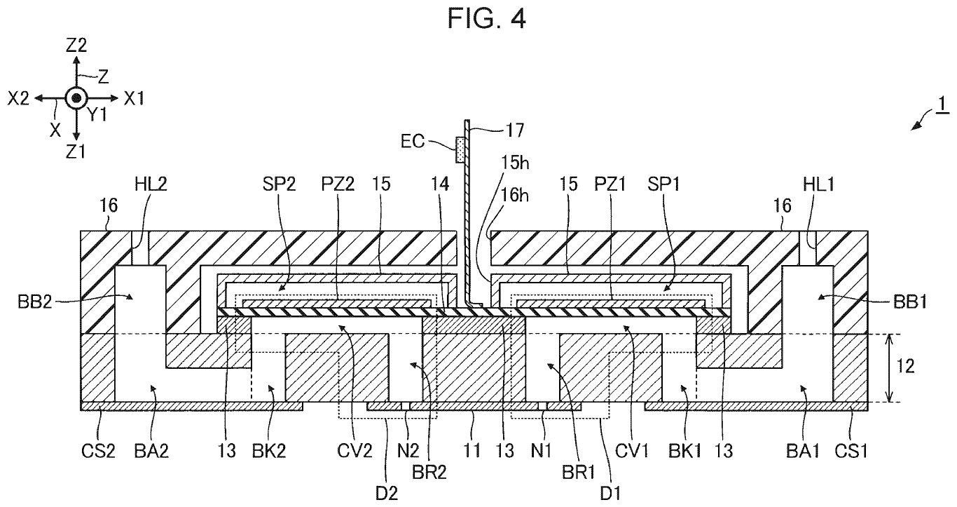

The liquid ejecting apparatus 100 includes a liquid ejecting head 1 provided with an ejecting portion D including a nozzle N that ejects inks, a drive signal generation unit 2 that generates a drive signal COM for driving the ejecting portion D, and an analysis portion 3 that analyzes residual vibration, which will be described below. The nozzle N will be described below with reference to FIGS. 3 and 4. Further, the liquid ejecting apparatus 100 includes a control unit 4 that controls each portion of the liquid ejecting apparatus 100, and a storage unit 5 that stores various types of information such as the print data IMG and a control program PG of the liquid ejecting apparatus 100. Further, the liquid ejecting apparatus 100 includes a maintenance unit 7 that executes a maintenance process of the liquid ejecting head 1, a medium transport mechanism 8 that transports the medium PP, a carriage transport mechanism 9 that reciprocates a carriage 91, and an ink container 60 that stores the inks. The carriage 91 will be described below with reference to FIG. 2.

In the present embodiment, a case is assumed in which the liquid ejecting head 1 and the drive signal generation unit 2 correspond to each other, and the liquid ejecting head 1 and the analysis portion 3 correspond to each other. For example, the liquid ejecting apparatus 100 may include a plurality of liquid ejecting heads 1, a plurality of drive signal generation units 2, and a plurality of analysis portions 3. In this case, for example, the plurality of drive signal generation units 2 correspond to the plurality of liquid ejecting heads 1 on a one-to-one basis, and the plurality of analysis portions 3 correspond to the plurality of liquid ejecting heads 1 on a one-to-one basis. Alternatively, the liquid ejecting apparatus 100 may include one liquid ejecting head 1, one drive signal generation unit 2 corresponding to the liquid ejecting head 1, and one analysis portion 3 corresponding to the liquid ejecting head 1.

In the present embodiment, a case is assumed in which the liquid ejecting apparatus 100 has four liquid ejecting heads 1 respectively corresponding to four types of inks of cyan, magenta, yellow, and black. That is, in the present embodiment, a case is assumed in which the liquid ejecting apparatus 100 includes four liquid ejecting heads 1, four drive signal generation units 2, and four analysis portions 3. Meanwhile, in the following, for convenience of description, as illustrated in FIG. 1, there may be a case where one liquid ejecting head 1 of the four liquid ejecting heads 1 and one drive signal generation unit 2 corresponding to the one liquid ejecting head 1 are focused on and described.

First, the control unit 4, the drive signal generation unit 2, and the storage unit 5 will be described before the liquid ejecting head 1 is to be described.

The control unit 4 is configured with one or a plurality of central processing units (CPU). The control unit 4 may be configured with a programmable logic device such as a field-programmable gate array (FPGA), instead of the CPU or in addition to the CPU. Further, for example, the control unit 4 generates a signal for controlling an operation of each portion of the liquid ejecting apparatus 100, such as a print signal SI and a waveform designation signal dCOM, by operating according to the control program PG stored in the storage unit 5.

Here, the waveform designation signal dCOM is a digital signal that defines a waveform of the drive signal COM. In addition, the drive signal COM is an analog signal used to drive the ejecting portion D. In the present embodiment, a case is assumed in which there is one drive signal COM output from the drive signal generation unit 2 to the liquid ejecting head 1, and a plurality of drive signals COM may be output from the drive signal generation unit 2 to the liquid ejecting head 1. The print signal SI is a digital signal for designating a type of operation of the ejecting portion D. Specifically, the print signal SI is a signal for designating the type of operation of the ejecting portion D by designating whether or not the drive signal COM is supplied to the ejecting portion D.

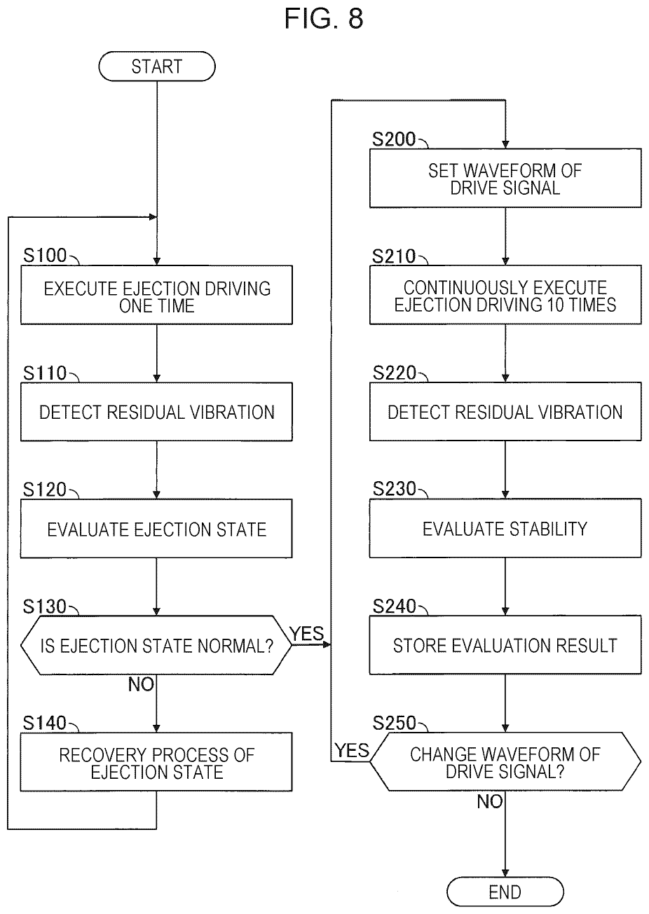

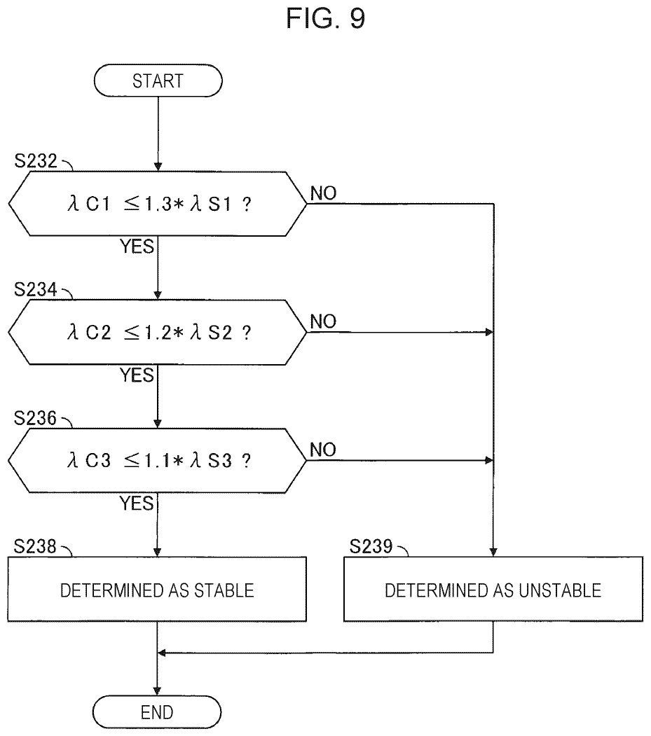

In the present embodiment, the control unit 4 functions as the evaluation control portion 40 by operating according to the control program PG stored in the storage unit 5. Details of the operation of the evaluation control portion 40 will be described with reference to FIGS. 8 and 9. For example, the evaluation control portion 40 evaluates a stability of ejection of the ink from the nozzle N based on residual vibration analyzed by the analysis portion 3. In the following, the stability of the ejection of the ink from the nozzle N is simply referred to as an ejection stability. The ejection stability means that, for example, ejection of the ink is stable in each ejection operation even when the ejection operation of ejecting the ink from the nozzle N is repeated a plurality of times. In the present embodiment, the evaluation control portion 40 also executes evaluation for an ejection state of the nozzle N, in addition to the evaluation of the ejection stability. In the evaluation of the ejection state, the evaluation control portion 40 determines, for example, whether or not the ejection state of the nozzle N is normal.

In this manner, in the present embodiment, the evaluation control portion 40 evaluates the ejection stability for the ink from the nozzle N. The evaluation control portion 40 is an example of a “control portion”.

The drive signal generation unit 2 includes, for example, a digital analog converter (DAC), and generates the drive signal COM based on the waveform designation signal dCOM supplied from the control unit 4. For example, the drive signal COM generated by the drive signal generation unit 2 includes a waveform defined by the waveform designation signal dCOM. The drive signal generation unit 2 outputs the drive signal COM generated based on the waveform designation signal dCOM to a switching circuit 18 included in the liquid ejecting head 1.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 4.

The liquid ejecting head 1 includes the switching circuit 18, a recording head 10, and a detection circuit 19. The detection circuit 19 is an example of a “detection portion”.

The recording head 10 includes M ejecting portions D. In the present embodiment, a case

is assumed in which the value M is an even number equal to or more than 2. In the following, among the M ejecting portions D provided in the recording head 10, an m-th ejecting portion D may be referred to as an ejecting portion D[m]. In this case, the variable m is a natural number that satisfies “1≤m≤M”. Further, in the following, when a component, a signal, or the like of the liquid ejecting apparatus 100 corresponds to the ejecting portion D[m] among the M ejecting portions D, the subscript [m] may be added to the reference numerals for representing the component, the signals, or the like.

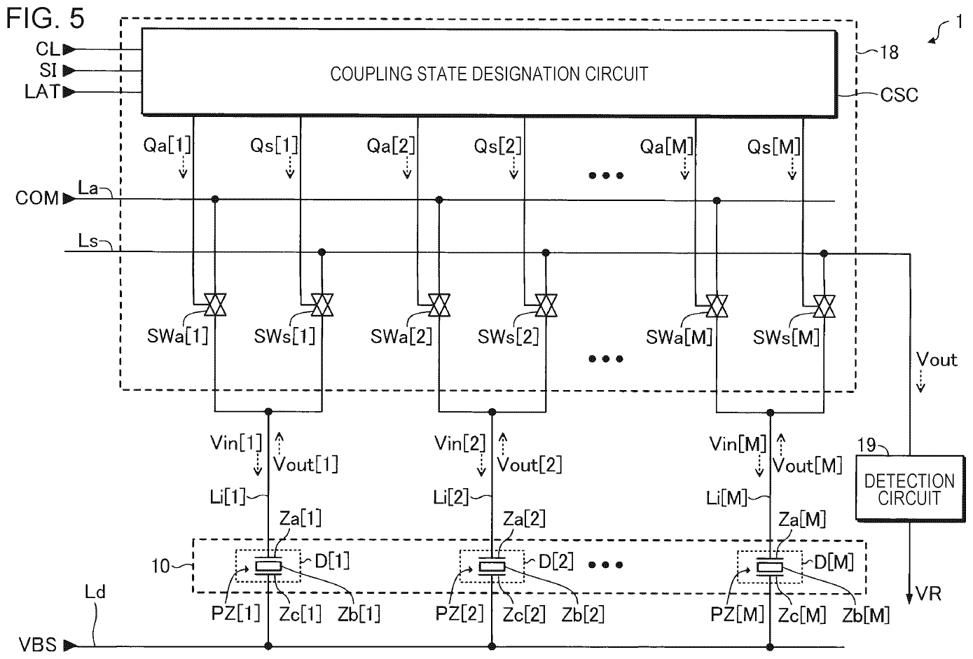

The switching circuit 18 switches whether or not to supply the drive signal COM to the ejecting portion D[m], based on the print signal SI. In the following, as illustrated in FIG. 5 and the like to be described below, the drive signal COM supplied to the ejecting portion D[m] among the drive signal COM may be referred to as an individual drive signal Vin[m]. Further, the switching circuit 18 switches whether or not to electrically couple the ejecting portion D[m] and the detection circuit 19 based on the print signal SI. When the ejecting portion D[m] and the detection circuit 19 are electrically coupled to each other, for example, a detection signal Vout[m] detected from the ejecting portion D[m] is supplied to the detection circuit 19 via the switching circuit 18. The detection signal Vout[m] is, for example, an analog signal indicating a waveform of residual vibration, which is vibration remaining in the ejecting portion D[m] after the ejecting portion D[m] is driven by the individual drive signal Vin[m]. Specifically, for example, the detection signal Vout[m] indicates a waveform of residual vibration of a diaphragm 14 after a piezoelectric element PZ[m] is driven. The piezoelectric element PZ and the diaphragm 14 will be described below with reference to FIGS. 3 and 4.

The detection circuit 19 generates a residual vibration signal VR[m] based on the detection signal Vout[m]. For example, the detection circuit 19 amplifies an amplitude of the detection signal Vout[m] or removes a noise component included in the detection signal Vout[m] to shape the detection signal Vout[m] into a waveform appropriate for a process in the analysis portion 3. Therefore, the residual vibration signal VR[m] is generated. For example, the detection circuit 19 may have a configuration including a negative feedback type amplifier for amplifying the detection signal Vout[m], a low-pass filter for attenuating a high-frequency component of the detection signal Vout[m], and a voltage follower that converts an impedance and outputs the residual vibration signal VR[m] having a low impedance.

For example, the residual vibration signal VR[m] generated based on the detection signal Vout[m] is an analog signal indicating a waveform of residual vibration of the diaphragm 14 after the piezoelectric element PZ[m] is driven by the individual drive signal Vin[m]. The detection circuit 19 outputs the residual vibration signal VR[m] generated based on the detection signal Vout[m] to the analysis portion 3. In this manner, the detection circuit 19 detects the residual vibration of the diaphragm 14 caused by driving the piezoelectric element PZ[m] based on the detection signal Vout[m].

The analysis portion 3 includes, for example, an analog to digital converter (ADC), and converts the analog residual vibration signal VR[m] into a digital signal. The analysis portion 3 analyzes, for example, the residual vibration detected by the detection circuit 19 by using the residual vibration signal VR[m] converted into a digital signal. The analysis portion 3 generates residual vibration information Vinf indicating an analysis result of the residual vibration, and outputs the generated residual vibration information Vinf to the control unit 4. The residual vibration information Vinf indicates, for example, a cycle, an amplitude, and a phase of the residual vibration. Meanwhile, the residual vibration information Vinf may indicate a part of the cycle, the amplitude, and the phase of the residual vibration. Alternatively, the residual vibration information Vinf may include information other than the cycle, the amplitude, and the phase of the residual vibration. The evaluation control portion 40 described above evaluates, for example, an ejection state of the nozzle N and an ejection stability based on the residual vibration information Vinf. The analysis portion 3 may be included in the control unit 4. For example, the control unit 4 may function as the analysis portion 3 by operating according to the control program PG stored in the storage unit 5. In addition, a part of the analysis portion 3 may be included in the control unit 4. Specifically, the control unit 4 may include a function of analyzing the residual vibration by using the residual vibration signal VR converted into a digital signal, the ADC being provided outside the control unit 4.

Further, in the present embodiment, as described above, the maintenance process is executed by the maintenance unit 7. For example, the maintenance unit 7 executes the maintenance process under the control of the control unit 4. For example, the maintenance process includes flushing processing of discharging inks from the ejecting portion D, wiping processing of wiping off a foreign matter such as an ink adhering to the vicinity of a nozzle N of the ejecting portion D with a wiper, and pumping processing of suctioning the ink in the ejecting portion D with a tube pump or the like.

The maintenance unit 7 includes a discharge ink receiving portion for receiving the discharged ink when the ink in the ejecting portion D is discharged, a wiper for wiping off a foreign matter such as an ink adhering to the vicinity of the nozzle N of the ejecting portion D, and a tube pump for suctioning the ink, air bubbles, and the like in the ejecting portion D, in the flushing processing. The discharge ink receiving portion, the wiper, and the tube pump are not illustrated.

Next, a schematic overall configuration of the liquid ejecting apparatus 100 will be described with reference to FIG. 2.

FIG. 2 is a configuration diagram schematically illustrating the liquid ejecting apparatus 100. In FIG. 2, the ink container 60, the medium transport mechanism 8, and the carriage transport mechanism 9 will be mainly described.

The ink container 60 stores inks. As the ink container 60, for example, a cartridge that can be attached to and detached from the liquid ejecting apparatus 100, a bag-shaped ink pack formed of a flexible film, or an ink tank that can be replenished with inks can be adopted. A type of the ink stored in the ink container 60 is not particularly limited, and is optional. In the present embodiment, as described above, a case is assumed in which the liquid ejecting apparatus 100 includes four liquid ejecting heads 1 respectively corresponding to four types of inks of cyan, magenta, yellow, and black. Therefore, in the present embodiment, the ink container 60 stores four types of inks of cyan, magenta, yellow, and black. Further, the ink container 60 supplies the stored ink to the liquid ejecting head 1.

The medium transport mechanism 8 transports the medium PP in a Y1 direction along a Y-axis under the control of the control unit 4. In the following, the Y1 direction and a Y2 direction opposite to the Y1 direction are collectively referred to as a Y-axis direction. In addition, in the following, an X1 direction along an X-axis that intersects the Y-axis and an X2 direction opposite to the X1 direction are collectively referred to as an X-axis direction. In addition, in the following, a Z1 direction along a Z-axis that intersects the X-axis and the Y-axis and a Z2 direction opposite to the Z1 direction are collectively referred to as a Z-axis direction. In the present embodiment, as an example, description will be performed by assuming that the X-axis, the Y-axis, and the Z-axis are orthogonal to each other. Meanwhile, the present disclosure is not limited to such an aspect. The X-axis, the Y-axis, and the Z-axis may intersect each other.

The carriage transport mechanism 9 reciprocates the plurality of liquid ejecting heads 1 in the X1 direction and the X2 direction under the control of the control unit 4. As illustrated in FIG. 2, the carriage transport mechanism 9 includes the substantially box-shaped carriage 91 that accommodates the plurality of liquid ejecting heads 1, and an endless belt 92 to which the carriage 91 is fixed. The ink container 60 may be stored in the carriage 91 together with the liquid ejecting head 1.

The liquid ejecting head 1 is driven by the drive signal COM under the control of the print signal SI, and ejects the ink in the Z1 direction from some or all of a plurality of nozzles N provided in the liquid ejecting head 1. That is, the liquid ejecting head 1 forms a desired image on a surface of the medium PP by ejecting the ink from the some or all of the plurality of nozzles N in conjunction with transport of the medium PP by the medium transport mechanism 8 and a reciprocating motion of the liquid ejecting head 1 by the carriage transport mechanism 9 and landing the ejected ink on the surface of the medium PP. In the present embodiment, as described above, the Z1 direction is a direction in which an ink is ejected from the nozzle N.

Next, a schematic structure of the liquid ejecting head 1 will be described with reference to FIGS. 3 and 4.

FIG. 3 is an exploded perspective view of the liquid ejecting head 1. FIG. 4 is a cross-sectional diagram taken along a line IV-IV illustrated in FIG. 3. A cross section of the line IV-IV is parallel to the XZ plane and passes through inlets HL1 and HL2, which will be described below. In FIGS. 3 and 4, in order to distinguish two nozzle rows Ln from each other, which will be described below, an end of a reference sign of a nozzle row Ln is added with a number “1” or “2”. In addition, in FIGS. 3 and 4, in order to facilitate the description, the number “1” is added to the end of the reference sign of the nozzle N included in a nozzle row Ln1, and the number “2” is added to the end of the reference sign of the nozzle N included in a nozzle row Ln2.

As illustrated in FIGS. 3 and 4, the liquid ejecting head 1 includes a nozzle substrate 11, compliance sheets CS1 and CS2, a communication plate 12, a pressure chamber substrate 13, a diaphragm 14, a sealing substrate 15, a flow path forming substrate 16, and a wiring substrate 17 at which an electronic component EC is mounted. The electronic component EC includes, for example, an electric circuit such as the switching circuit 18 and the detection circuit 19. For example, the recording head 10 is electrically coupled to the switching circuit 18, the detection circuit 19, and the like via the wiring substrate 17.

As illustrated in FIG. 3, the recording head 10 includes, for example, the nozzle substrate 11, the compliance sheets CS1 and CS2, the communication plate 12, the pressure chamber substrate 13, the diaphragm 14, the sealing substrate 15, and the flow path forming substrate 16.

The nozzle substrate 11 is a plate-shaped member elongated in the Y-axis direction and extending substantially parallel to an XY plane. Here, “substantially parallel” is a concept that includes not only a case of being completely parallel but also a case of being considered to be parallel when an error is considered. In the present embodiment, “substantially parallel” is a concept that includes a case where it can be regarded as parallel when an error of approximately 10% is considered. The “substantially vertical” described below is also a concept that includes a case where it is considered to be vertical when an error is taken into consideration, in addition to a case where it is completely vertical, as in the case of the “substantially parallel”. The nozzle substrate 11 is manufactured, for example, by processing a silicon single crystal substrate using a semiconductor manufacturing technology such as etching, and any known material and manufacturing method may be adopted to manufacture the nozzle substrate 11.

M nozzles N are formed at the nozzle substrate 11. Here, the nozzle Nis a through-hole

provided in the nozzle substrate 11. In the present embodiment, a case is assumed in which the plurality of nozzles N formed in the nozzle substrate 11 include a plurality of nozzles N1 arranged to extend in the Y-axis direction, and a plurality of nozzles N2 arranged to extend in the Y-axis direction at a position in the X2 direction when viewed from the plurality of nozzles N1. In the following, the plurality of nozzles N1 arranged to extend in the Y-axis direction are referred to as the nozzle row Ln1, and the plurality of nozzles N2 arranged to extend in the Y-axis direction are referred to as the nozzle row Ln2. For example, the number of nozzles N included in each of the nozzle rows LN1 and Ln2 is half the value M. In the following, the nozzle row Ln1 and the nozzle row Ln2 may be collectively referred to as a nozzle row Ln. In addition, in FIGS. 3 and 4, in order to facilitate the description, in the liquid ejecting head 1, a number “1” is added to an end of a reference sign of a component corresponding to the nozzle row Ln1, and a number “2” is added to an end of a reference sign of a component corresponding to the nozzle row Ln2.

As illustrated in FIGS. 3 and 4, a communication plate 12 is provided at a position in the Z2 direction when viewed from a nozzle substrate 11. The communication plate 12 is a plate-shaped member elongated in the Y-axis direction and extending substantially parallel to the XY plane. The communication plate 12 is manufactured, for example, by processing a silicon single crystal substrate using semiconductor manufacturing technology, and any known material and manufacturing method may be adopted to manufacture the communication plate 12.

A flow path for inks is formed in the communication plate 12. Specifically, the communication plate 12 is formed with one supply flow path BA1 provided to extend in the Y-axis direction, and one supply flow path BA2 provided to extend in the Y-axis direction at a position in the X2 direction when viewed from the supply flow path BA1. In addition, the communication plate 12 is formed with a plurality of coupling flow paths BK1 corresponding to the plurality of nozzles N1, a plurality of coupling flow paths BK2 corresponding to the plurality of nozzles N2, a plurality of communication flow paths BR1 corresponding to the plurality of nozzles N1, and a plurality of communication flow paths BR2 corresponding to the plurality of nozzles N2.

As illustrated in FIG. 4, the coupling flow path BK1 is provided to communicate with the supply flow path BA1 and extend in the Z-axis direction at a position in the X2 direction when viewed from the supply flow path BA1. The communication flow path BR1 is provided to extend in the Z-axis direction at a position in the X2 direction when viewed from the coupling flow path BK1. The communication flow path BR1 communicates with the nozzle N1 corresponding to the communication flow path BR1. The coupling flow path BK2 is provided to communicate with the supply flow path BA2 and extend in the Z-axis direction at a position in the X1 direction when viewed from the supply flow path BA2. The communication flow path BR2 is provided to extend in the Z-axis direction at a position, which is a position in the X1 direction when viewed from the coupling flow path BK2 and in the X2 direction when viewed from the communication flow path BR1. The communication flow path BR2 communicates with the nozzle N2 corresponding to the communication flow path BR2.

The supply flow paths BA1 and BA2 are also referred to as a supply flow path BA without particular distinction, the coupling flow paths BK1 and BK2 are also referred to as a coupling flow path BK without particular distinction, and the communication flow paths BR1 and BR2 are also referred to as a communication flow path BR without particular distinction.

As illustrated in FIGS. 3 and 4, the pressure chamber substrate 13 is provided at a position in the Z2 direction when viewed from the communication plate 12. The pressure chamber substrate 13 is a plate-shaped member elongated in the Y-axis direction and extending substantially parallel to the XY plane. The pressure chamber substrate 13 is manufactured, for example, by processing a silicon single crystal substrate using semiconductor manufacturing technology, and any known material and manufacturing method may be adopted to manufacture the pressure chamber substrate 13.

A flow path for inks is formed in the pressure chamber substrate 13. Specifically, the pressure chamber substrate 13 is formed with a plurality of pressure chambers CV1 corresponding to the plurality of nozzles N1 and a plurality of pressure chambers CV2 corresponding to the plurality of nozzles N2. Of these, the pressure chamber CV1 is provided to couple an end portion of the coupling flow path BK1 in the X2 direction and an end portion of the communication flow path BR1 in the X1 direction when viewed in the Z-axis direction, and extend in the X-axis direction. When viewed in the Z-axis direction, the pressure chamber CV2 is provided to couple an end portion of the coupling flow path BK2 in the X1 direction and an end portion of the communication flow path BR2 in the X2 direction, and extend in the X-axis direction. The pressure chambers CV1 and CV2 are also referred to as a pressure chamber CV without particular distinction.

As illustrated in FIGS. 3 and 4, the diaphragm 14 is provided at a position in the Z2 direction when viewed from the pressure chamber substrate 13. The diaphragm 14 is a plate-shaped member elongated in the Y-axis direction and extending substantially parallel to the XY plane, and is a member that can vibrate elastically. In the present embodiment, the diaphragm 14 has, for example, an elastic layer made of silicon oxide and an insulating layer made of zirconium oxide provided at a position in the Z2 direction when viewed from the elastic layer. That is, in the present embodiment, a surface of the diaphragm 14 in the Z2 direction is formed with a non-conductive member. Here, a surface of an element A in a first direction is a surface of the element A, which is substantially vertical to the first direction among surfaces of the element A, and is a surface which is visible when the element A is viewed in the first direction from a second direction. The second direction is a direction opposite to the first direction. The elastic layer of the diaphragm 14 is not limited to the elastic layer made of silicon oxide. In the same manner, the insulating layer of the diaphragm 14 is not limited to the insulating layer made of zirconium oxide.

As illustrated in FIGS. 3 and 4, a plurality of piezoelectric elements PZ1 corresponding to the plurality of pressure chambers CV1 and a plurality of piezoelectric elements PZ2 corresponding to the plurality of pressure chambers CV2 are provided at a position in the Z2 direction when viewed from the diaphragm 14. The piezoelectric elements PZ1 and PZ2 are also referred to as a piezoelectric element PZ without particular distinction. The piezoelectric element PZ is driven by the drive signal COM being supplied.

Although not illustrated in FIGS. 3 and 4, the piezoelectric element PZ has a common electrode Zc to which a predetermined bias potential VBS is supplied, an individual electrode Za to which the individual drive signal Vin is supplied, and a piezoelectric body Zb provided between the individual electrode Za and the common electrode Zc, as illustrated in FIG. 5. For example, the individual electrode Za, the piezoelectric body Zb, and the common electrode Zc are provided in this order along the Z2 direction on the surface of the diaphragm 14 in the Z2 direction. Here, an expression “an element B is formed at the surface of the element A” in the present specification is not intended to limit the configuration to a configuration in which the element A and the element B are in direct contact with each other. That is, a configuration in which an element C is formed at the surface of the element A and the element B is formed at a surface of the element C is also included in the concept of “the element B is formed at the surface of the element A” insofar as the element A and the element B overlap at least in part in plan view.

In the present embodiment, the common electrode Zc is a so-called upper electrode, and the individual electrode Za is a so-called lower electrode, and the common electrode Zc may be a lower electrode and the individual electrode Za may be an upper electrode.

The piezoelectric element PZ is a passive element that is deformed in response to a potential change of the drive signal COM supplied to the individual electrode Za as the individual drive signal Vin. In other words, the piezoelectric element PZ is an example of an energy conversion element that converts the electric energy of the drive signal COM into kinetic energy. Specifically, the piezoelectric element PZ is driven and deformed in response to a potential change of the drive signal COM.

As illustrated in FIGS. 3 and 4, since the piezoelectric element PZ is provided on the surface of the diaphragm 14 in the Z2 direction, the diaphragm 14 vibrates in conjunction with the deformation of the piezoelectric element PZ. That is, the diaphragm 14 vibrates by driving the piezoelectric element PZ. When the diaphragm 14 vibrates, a pressure in the pressure chamber CV fluctuates. Then, the pressure inside the pressure chamber CV fluctuates, and an ink with which an inside of the pressure chamber CV is filled is ejected from the nozzle N via the communication flow path BR. In this manner, the pressure chamber CV is filled with the ink, and a pressure for ejecting the ink from the nozzle Nis applied by the vibration of the diaphragm 14. In addition, the vibration remaining in the ejecting portion D[m] described in FIG. 1 can be regarded as, for example, vibration remaining in the ink in the pressure chamber CV of the ejecting portion D. Therefore, residual vibration of the diaphragm 14, that is, the residual vibration of the ejecting portion D[m] indicates a behavior of the ink in the pressure chamber CV of the ejecting portion D.

As illustrated in FIGS. 3 and 4, the sealing substrate 15 for protecting the plurality of piezoelectric elements PZ1 and the plurality of piezoelectric elements PZ2 is provided at a position in the Z2 direction when viewed from the pressure chamber substrate 13. The sealing substrate 15 is a plate-shaped member elongated in the Y-axis direction and extending substantially parallel to the XY plane. The sealing substrate 15 is manufactured, for example, by processing a silicon single crystal substrate using semiconductor manufacturing technology, and any known material and manufacturing method may be adopted to manufacture the sealing substrate 15.

As illustrated in FIG. 4, a surface of the sealing substrate 15 in the Z1 direction is provided with a recess portion for covering the plurality of piezoelectric elements PZ1 and a recess portion for covering the plurality of piezoelectric elements PZ2. In the following, a sealing space covering the plurality of piezoelectric elements PZ1 and formed between the diaphragm 14 and the sealing substrate 15 is referred to as a sealing space SP1, and a sealing space covering the plurality of piezoelectric elements PZ2 and formed between the diaphragm 14 and the sealing substrate 15 is referred to as a sealing space SP2. Further, the sealing spaces SP1 and SP2 are also referred to as a sealing space SP without particular distinction. The sealing space SP is a space for sealing the piezoelectric element PZ and preventing the piezoelectric element PZ from deteriorating due to an influence of moisture or the like.

The sealing substrate 15 is provided with a through-hole 15h. The through-hole 15h is a hole that is located between the sealing space SP1 and the sealing space SP2 when the sealing substrate 15 is viewed in the Z1 direction, and penetrates from the surface of the sealing substrate 15 in the Z1 direction to the surface of the sealing substrate 15 in the Z2 direction. The wiring substrate 17 is inserted into the through-hole 15h.

As illustrated in FIGS. 3 and 4, the flow path forming substrate 16 is provided at a position in the Z2 direction when viewed from the communication plate 12. The flow path forming substrate 16 is a plate-shaped member elongated in the Y-axis direction and extending substantially parallel to the XY plane. The flow path forming substrate 16 is formed by, for example, injection molding of a resin material, and any known material and manufacturing method may be adopted to manufacture the flow path forming substrate 16.

As illustrated in FIG. 4, a flow path for inks is formed in the flow path forming substrate 16. Specifically, the flow path forming substrate 16 is formed with one supply flow path BB1 and one supply flow path BB2. Among these, the supply flow path BB1 is provided to communicate with the supply flow path BA1 and extend in the Y-axis direction at a position in the Z2 direction when viewed from the supply flow path BA1. The supply flow path BB2 is provided to communicate with the supply flow path BA2 and extend in the Y-axis direction at a position, which is a position in the Z2 direction when viewed from the supply flow path BA2 and in the X2 direction when viewed from the supply flow path BB1. The supply flow paths BB1 and BB2 are also referred to as a supply flow path BB without particular distinction.

The flow path forming substrate 16 is provided with the inlet HL1 communicating with the supply flow path BB1 and the inlet HL2 communicating with the supply flow path BB2. The ink is supplied from the ink container 60 to the supply flow path BB1 via the inlet HL1. The ink supplied from the ink container 60 to the supply flow path BB1 via the inlet HL1 flows into the supply flow path BA1. The pressure chamber CV1 is filled with a part of the ink flowing into the supply flow path BA1, via the coupling flow path BK1. When the piezoelectric element PZ1 is driven by the drive signal COM, the part of the ink filled in the pressure chamber CV1 is ejected from the nozzle N1 via the communication flow path BR1.

In addition, the ink is supplied from the ink container 60 to the supply flow path BB2 via the inlet HL2. The ink supplied from the ink container 60 to the supply flow path BB2 via the inlet HL2 flows into the supply flow path BA2. The pressure chamber CV2 is filled with a part of the ink flowing into the supply flow path BA2, via the coupling flow path BK2. When the piezoelectric element PZ2 is driven by the drive signal COM, the part of the ink filled in the pressure chamber CV2 is ejected from the nozzle N2 via the communication flow path BR2.

The flow path forming substrate 16 is provided with a through-hole 16h. The through-hole 16h is a hole that is located between the supply flow path BB1 and the supply flow path BB2 when the flow path forming substrate 16 is viewed in the Z1 direction, and penetrates from a surface of the flow path forming substrate 16 in the Z1 direction to the surface of the flow path forming substrate 16 in the Z2 direction. The wiring substrate 17 is inserted into the through-hole 16h.

As illustrated in FIGS. 3 and 4, the wiring substrate 17 is mounted on a surface of the diaphragm 14 in the Z2 direction. The wiring substrate 17 is a component for electrically coupling the liquid ejecting head 1 to the control unit 4. As the wiring substrate 17, for example, a flexible wiring substrate such as a flexible printed circuit (FPC) or a flexible flat cable (FFC) is preferably adopted. As described above, the electronic component EC including the switching circuit 18, the detection circuit 19, and the like is mounted at the wiring substrate 17.

As illustrated in FIGS. 3 and 4, the compliance sheet CS1 is provided to close the supply flow path BA1 and the coupling flow path BK1, and the compliance sheet CS2 is provided to close the supply flow path BA2 and the coupling flow path BK2, at a position in the Z1 direction when viewed from the communication plate 12. The compliance sheets CS1 and CS2 are also referred to as a compliance sheet CS without particular distinction. The compliance sheet CS is a plate-shaped member elongated in the Y-axis direction and extending substantially parallel to the XY plane. The compliance sheet CS is formed with an elastic material, and absorbs the pressure fluctuation of the ink inside the supply flow path BA and the coupling flow path BK.

Here, as illustrated in FIG. 4, the ejecting portion D1 includes the piezoelectric element PZ1, the pressure chamber CV1, the nozzle N1 communicating with the pressure chamber CV1, and a portion of the diaphragm 14 that is in contact with the piezoelectric element PZ1. In the same manner, the ejecting portion D2 includes the piezoelectric element PZ2, the pressure chamber CV2, the nozzle N2 communicating with the pressure chamber CV2, and a portion of the diaphragm 14 that is in contact with the piezoelectric element PZ2. The ejecting portions D1 and D2 are also referred to as an ejecting portion D without particular distinction. In addition, in the following, between a first element and a second element included in one ejecting portion D, the second element is also referred to as the second element corresponding to the first element. Specifically, for example, the piezoelectric element PZ included in the ejecting portion D having one nozzle N is also referred to as the piezoelectric element PZ corresponding to one nozzle N.

In addition, although not illustrated, the liquid ejecting head 1 has a cap for sealing a nozzle surface, which is a surface of the nozzle substrate 11 in the Z1 direction. The cap seals the nozzle surface of the nozzle substrate 11 at which the nozzle N is formed in a period in which the ink is not ejected from the nozzle N.

Next, an outline of the liquid ejecting head 1 will be described with reference to FIG. 5.

FIG. 5 is a block diagram illustrating an example of a configuration of the liquid ejecting head 1.

As described in FIG. 1, the liquid ejecting head 1 includes the recording head 10, the switching circuit 18, and the detection circuit 19. Further, the liquid ejecting head 1 has a wiring La through which the drive signal COM is supplied from the drive signal generation unit 2, and a wiring Ls through which the detection signal Vout is supplied to the detection circuit 19. Further, the liquid ejecting head 1 has a wiring Li[m] through which the individual drive signal Vin[m] is supplied to the ejecting portion D[m] and a wiring Ld through which the bias potential VBS is supplied. In the present embodiment, a case is assumed in which the drive signal COM supplied to the wiring La is the drive signal COM for ejecting inks from the nozzle N.

The switching circuit 18 includes M switches SWa[1] to SWa[M] corresponding to the M ejecting portions D[1] to D[M] on a one-to-one basis and M switches SWs[1] to SWs[M] corresponding to the M ejecting portions D[1] to D[M] on a one-to-one basis.

Further, the switching circuit 18 includes a coupling state designation circuit CSC. The coupling state designation circuit CSC designates a coupling state of each of the M switches SWa and the M switches SWs. For example, the coupling state designation circuit CSC generates coupling state designation signals Qa[m] and Qs[m], based on at least some signals of the print signal SI and a latch signal LAT supplied from the control unit 4.

For example, the coupling state designation signal Qa[m] is a signal for designating ON or OFF of the switch SWa[m], and the coupling state designation signal Qs[m] is a signal for designating ON or OFF of the switch SWs[m].

The switch SWa[m] switches conduction and non-conduction between the wiring La and the individual electrode Za[m] of the piezoelectric element PZ[m] provided in the ejecting portion D[m], based on the coupling state designation signal Qa[m]. That is, the switch SWa[m] switches conduction and non-conduction between the wiring La and the wiring Li[m] coupled to the individual electrode Za[m], based on the coupling state designation signal Qa[m]. In the present embodiment, the switch SWa[m] is turned on when the coupling state designation signal Qa[m] is at a high level, and is turned off when the coupling state designation signal Qa[m] is at a low level. When the switch SWa[m] is turned on, the drive signal COM supplied to the wiring La is supplied to the individual electrode Za[m] of the ejecting portion D[m] as the individual drive signal Vin[m] via the wiring Li[m]. That is, the individual drive signal Vin[m] is the drive signal COM supplied to the piezoelectric element PZ[m] included in the ejecting portion D[m] via the switch SWa[m].

The switch SWs[m] switches conduction and non-conduction between the wiring Ls and the individual electrode Za[m] of the piezoelectric element PZ[m] provided in the ejecting portion D[m], based on the coupling state designation signal Qs[m]. That is, the switch SWs[m] switches conduction and non-conduction between the wiring Ls and the wiring Li[m] coupled to the individual electrode Za[m], based on the coupling state designation signal Qs[m]. In the present embodiment, the switch SWs[m] is turned on when the coupling state designation signal Qs[m] is at a high level, and is turned off when the coupling state designation signal Qs[m] is at a low level.

For example, the coupling state designation signal Qs[m] becomes a high level when the residual vibration of the ejecting portion D[m] is detected. In the following, the ejecting portion D in which the residual vibration is detected may be referred to as the ejecting portion D as a detection target. In addition, in the following, the nozzle N included in the ejecting portion D, which is a detection target, may be referred to as the nozzle N as a detection target. When the switch SWs[m] is turned on, the detection signal Vout[m] indicating a potential of the individual electrode Za[m] of the piezoelectric element PZ[m] included in the ejecting portion D[m] as a detection target is supplied to the detection circuit 19 via the wiring Li[m] and the wiring Ls. The detection circuit 19 generates the residual vibration signal VR[m] based on the detection signal Vout[m].

As described above, the residual vibration signal VR[m] is used for evaluating an ejection state of the nozzle N and evaluating an ejection stability. Specifically, in the evaluation of the ejection state of the nozzle N, for example, the residual vibration signal VR[m] indicating residual vibration of the diaphragm 14 caused by executing ejection driving of driving the piezoelectric element PZ by the drive signal COM for ejecting the ink from the nozzle N only one time is used. For example, when it can be considered that the residual vibration of the diaphragm 14 caused by one ejection driving coincides with residual vibration in a normal situation assumed in advance, it is determined that the ejection state of the nozzle N is normal.

Meanwhile, when the ejection operation is continuously executed a plurality of times even when it is determined that the ejection state of the nozzle N is normal, vibration of a meniscus becomes large, and there is a concern that the ejection of the ink becomes unstable due to winding of air bubbles due to the vibration of the meniscus. Therefore, in the method of evaluating the ejection stability based on the residual vibration signal VR[m] indicating the residual vibration of the diaphragm 14 caused by one ejection driving, there is a concern that the ejection stability cannot be evaluated with high accuracy. Therefore, in the present embodiment, the residual vibration signal VR[m] indicating the residual vibration of the diaphragm 14 caused by executing the ejection driving a plurality of times is used for evaluating the ejection stability. Therefore, in the present embodiment, the ejection stability can be evaluated with high accuracy.

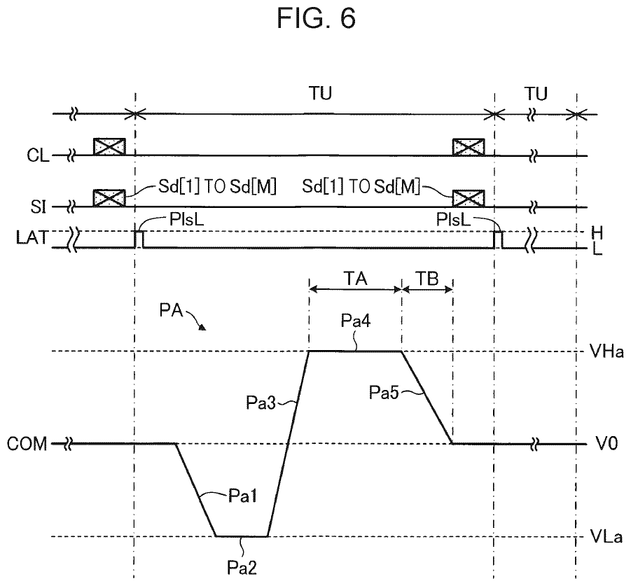

Next, an operation of the liquid ejecting apparatus 100 in a unit period TU will be described with reference to FIG. 6.

FIG. 6 is a timing chart illustrating an example of the operation of the liquid ejecting apparatus 100 in the unit period TU. In the present embodiment, when the liquid ejecting apparatus 100 executes a printing process, a printing process period including one or a plurality of unit periods TU is set as an operation period of the liquid ejecting apparatus 100. The unit period TU is, for example, a drive cycle of the M ejecting portions D. For example, the liquid ejecting apparatus 100 according to the present embodiment can drive each ejecting portion D for a printing process in each unit period TU. Further, the liquid ejecting apparatus 100 according to the present embodiment can drive the ejecting portion D as a detection target and detect the detection signal Vout[m] from the ejecting portion D as a detection target in each unit period TU.

The control unit 4 outputs the latch signal LAT having a pulse PlsL. Therefore, the control unit 4 defines the unit period TU as a period from rising of the pulse PlsL to rising of the next pulse PlsL.

The print signal SI includes, for example, M individual designation signals Sd[1] to Sd[M] corresponding to the M ejecting portions D[1] to D[M] on a one-to-one basis. The individual designation signal Sd[m] designates a mode of the driving of the ejecting portion D[m] in each unit period TU when the liquid ejecting apparatus 100 executes the printing process.

The control unit 4 supplies the print signal SI including the individual designation signals Sd[1] to Sd[M] to the coupling state designation circuit CSC in synchronization with a clock signal CL before each unit period TU in which the printing process is executed. The coupling state designation circuit CSC generates the coupling state designation signals Qa[m] and Qs[m] based on the individual designation signal Sd[m] in the unit period TU.

For example, the ejecting portion D[m] is designated as any of the ejecting portion D that forms a dot, the ejecting portion D that does not form a dot, and the ejecting portion D as a detection target, by the individual designation signal Sd[m], in a unit period TP during which the printing process is executed. The ejecting portion D that forms a dot is the ejecting portion D in which the piezoelectric element PZ of the ejecting portion D is driven such that an ink is ejected from the nozzle N of the ejecting portion D. That is, the ejecting portion D that is an ejection driving target for driving the piezoelectric element PZ by the drive signal COM for ejecting the ink from the nozzle N. In addition, the ejecting portion D that does not form the dot is the ejecting portion D in which the piezoelectric element PZ of the ejecting portion D is driven such that the ink is not ejected from the nozzle N of the ejecting portion D.

First, an operation of the coupling state designation circuit CSC or the like when a driving mode as the ejecting portion D for forming a dot is designated by the individual designation signal Sd[m] will be described. When a driving mode as the ejecting portion D for forming a dot is designated by the individual designation signal Sd[m], for example, the coupling state designation circuit CSC respectively sets the coupling state designation signal Qa[m] to a high level and the coupling state designation signal Qs[m] to a low level, in the unit period TU. Therefore, the drive signal COM is supplied to the ejecting portion D that forms the dot from the drive signal generation unit 2.

For example, the drive signal generation unit 2 outputs the drive signal COM having a pulse PA. The pulse PA is, for example, a pulse for ejecting the ink from the nozzle N. The pulse PA is a waveform in which a potential of the drive signal COM is changed from a potential V0 (intermediate potential and reference potential) to a potential VLa (minimum potential and expansion potential) lower than the potential V0 and a potential VHa (maximum potential and contraction potential) higher than the potential V0, and returns to the potential V0. The potential V0 is a potential at a start and an end of the pulse PA, and is a reference potential of the drive signal COM.

For example, the pulse PA has a waveform element Pa1 in which a potential is changed from the potential V0 to the potential VLa, a waveform element Pa2 in which the potential is maintained at the potential VLa at an end of the waveform element Pa1, and a waveform element Pa3 in which the potential is changed from the potential VLa to the potential VHa. Further, the pulse PA includes a waveform element Pa4 in which the potential is maintained at the potential VHa at an end of the waveform element Pa3, and a waveform element Pa5 in which the potential is changed from the potential VHa to the potential V0.

The waveform elements Pa1 and Pa5 are expansion elements for displacing the piezoelectric body Zb in the Z2 direction. In the expansion element, the potential of the drive signal COM is changed for driving the piezoelectric element PZ to expand a volume of the pressure chamber CV. Therefore, in the waveform elements Pa1 and Pa5, the potential of the drive signal COM is changed to expand the volume of the pressure chamber CV. When the volume of the pressure chamber CV expands, a surface of the ink in the nozzle Nis pulled in the Z2 direction, which is a direction opposite to an ejection direction. In the following, the pulling of the surface of the ink in the nozzle N in the direction opposite to the ejection direction may be referred to as a pull.

In addition, the waveform element Pa3 is a contraction element for displacing the piezoelectric body Zb in the Z1 direction. In the contraction element, the potential of the drive signal COM is changed for driving the piezoelectric element PZ to contract the volume of the pressure chamber CV. Therefore, in the waveform element Pa3, the potential of the drive signal COM is changed to contract the volume of the pressure chamber CV. When the volume of the pressure chamber CV is contracted, the surface of the ink in the nozzle N is pushed out in the Z1 direction, which is the ejection direction. In the following, the act of pushing the surface of the ink in the nozzle N in the ejection direction may be referred to as a push.

In addition, the waveform elements Pa2 and Pa4 are maintenance elements for maintaining a position of the piezoelectric body Zb in the Z-axis direction. For example, in the waveform element Pa2, the potential of the drive signal COM is maintained for driving the piezoelectric element PZ to maintain the volume of the pressure chamber CV expanded by the waveform element Pa1. In addition, for example, in the waveform element Pa4, the potential of the drive signal COM is maintained for driving the piezoelectric element PZ to maintain the volume of the pressure chamber CV contracted by the waveform element Pa3.

In this manner, the pulse PA is a so-called pull-push-pull waveform. Meanwhile, a waveform of the drive signal COM for ejecting the ink from the nozzle N is not limited to the pull-push-pull waveform.

The pulse PA is determined such that a predetermined amount of ink is ejected from the ejecting portion D[m] when the individual drive signal Vin[m] having the pulse PA is supplied to the ejecting portion D[m]. In the present embodiment, a case is assumed in which the volume of the pressure chamber CV provided in the ejecting portion D[m] is reduced when a potential of the individual drive signal Vin[m] is a high potential as compared with a case where the potential is a low potential. Therefore, when the ejecting portion D[m] is driven by the individual drive signal Vin[m] having the pulse PA, the ink in the ejecting portion D[m] is ejected from the nozzle N by the waveform element Pa3 in which the potential of the individual drive signal Vin[m] is changed from the low potential to the high potential.

For example, the waveform elements Pa1, Pa2, Pa3, Pa4, and Pa5 included in the pulse PA are determined based on an ejection characteristic of the ink by the ejecting portion D, the ejection stability, and the like. The ejection characteristic of the ink is, for example, the amount of ink ejected as ink droplets, an ejection rate of the ejected ink droplets, or the like. In the present embodiment, a case is assumed in which, among the waveform elements Pa1, Pa2, Pa3, Pa4, and Pa5 determined based on the ejection characteristic of the ink and the like, a length TA of the waveform element Pa4 and a length TB of the waveform element Pa5 are adjusted to improve the ejection stability. In the present embodiment, a case is assumed in which a start timing of the waveform element Pa4 is not changed before and after the adjustment of the length TA, and an end timing of the waveform element Pa5 is not changed before and after the adjustment of the length TB. That is, in the present embodiment, a total of the length TA of the waveform element Pa4 and the length TB of the waveform element Pa5 is not changed before and after the adjustment.

Therefore, for example, when the length TB is short, the potential change amount per unit time of the waveform element Pa5, that is, an inclination of the waveform element Pa5 is more than when the length TB is long. When the inclination of the waveform element Pa5 is large, a vibration damping capacity for attenuating the residual vibration of the ejecting portion D is more than the vibration damping capacity when the inclination of the waveform element Pa5 is small. Therefore, when the inclination of the waveform element Pa5 is large, a vibration damping capacity for attenuating the vibration of the meniscus is higher than that when the inclination of the waveform element Pa5 is small, and thus the ejection stability tends to be improved. On the other hand, when the length TB is increased, it is necessary to increase a length of the entire pulse PA accordingly or to decrease any of the waveform elements Pal, Pa2, Pa3, and Pa4. The former may lead to a decrease in drive frequency, and the lengths of the waveform elements Pa1, Pa2, and Pa3 among the latter may affect the ejection itself. Therefore, in the present embodiment, when the length TB of the waveform element Pa5 is increased, the length TA of the waveform element Pa4 is decreased instead. Meanwhile, a method of determining the waveform of the pulse PA for improving the ejection stability is not limited to adjusting the length TA of the waveform element Pa4 and the length TB of the waveform element Pa5. The waveform elements Pa1, Pa2, Pa3, Pa4, and Pa5 included in the pulse PA may be appropriately adjusted to improve the ejection stability in a range in which the ejection characteristic of the ink become a desired ejection characteristic.

Next, an operation of the coupling state designation circuit CSC or the like when a driving mode as the ejecting portion D that does not form a dot is designated by the individual designation signal Sd[m] will be described. When the driving mode as the ejecting portion D that does not form the dot is designated by the individual designation signal Sd[m], for example, the coupling state designation circuit CSC sets the coupling state designation signals Qa[m] and Qs[m] to a low level in the unit period TU. Therefore, when a leakage current does not occur, a potential of the individual electrode Za of the piezoelectric element PZ included in the ejecting portion D that does not form the dot is maintained at a potential before the coupling state designation signal Qa[m] is set to a low level, for example, a potential VO.

Next, an operation of the coupling state designation circuit CSC or the like when a driving mode of the ejecting portion D as a detection target is designated by the individual designation signal Sd[m] will be described. In the following, the operation of the coupling state designation circuit CSC or the like when the driving mode of the detection target ejecting portion D is designated by the individual designation signal Sd[m] will be described with reference to a case of evaluating an ejection stability. In the following, the unit period TU in which residual vibration for evaluating the ejection stability is detected may be referred to as the unit period TU for detection. When evaluating the ejection stability, for example, the ejecting portion D as a detection target operates as the ejecting portion D that forms a dot in each of K unit periods TU from the unit period TU before the K unit periods TU for detection to the unit period TU immediately before the unit period TU for detection. That is, the piezoelectric element PZ included in the ejecting portion D, which is a detection target, is driven by the drive signal COM for ejecting an ink from the nozzle N in each of the K consecutive unit periods TU before the unit period TU for detection. In the present embodiment, a case is assumed in which the value K is a natural number of 10 or more, and the value K is not particularly limited as long as the value K is a natural number of 2 or more.

For example, when the driving mode of the ejecting portion D, which is a detection target, is designated by the individual designation signal Sd[m], the coupling state designation circuit CSC sets the coupling state designation signal Qs[m] to a high level in the unit period TU for detection. Further, the coupling state designation circuit CSC sets the coupling state designation signal Qa[m] to a low level in the unit period TU for detection.

In this case, the piezoelectric element PZ[m] included in the ejecting portion D[m] as a detection target is driven by the drive signal COM in each of the K consecutive unit periods TU before the unit period TU for detection. Therefore, the piezoelectric element PZ[m] is displaced by the pulse PA of the drive signal COM in each of the K consecutive unit periods TU before the unit period TU for detection. As a result, vibration is generated in the ejecting portion D[m] of the detection target before the unit period TU for detection. The vibration generated before the unit period TU for detection also remains in the unit period TU for detection. Then, in the unit period TU for detection, a potential of the individual electrode Za[m] of the piezoelectric element PZ[m] included in the ejecting portion D[m] as a detection target is changed in accordance with the residual vibration generated in the ejecting portion D[m]. That is, in the unit period TU for detection, the potential of the individual electrode Za of the piezoelectric element PZ included in the ejecting portion D as a detection target becomes a potential corresponding to an electromotive force of the piezoelectric element PZ caused by the residual vibration generated in the ejecting portion D as a detection target. The potential of the individual electrode Za is detected as the detection signal Vout in the unit period TU for detection.

For example, the coupling state designation circuit CSC may set the coupling state designation signal Qs[m] to a high level in a former half period of the unit period TU for detection, and set the coupling state designation signal Qs[m] to a low level in a latter half period of the unit period TU for detection. Further, the coupling state designation signals Qa and Qs corresponding to the ejecting portions D other than the ejecting portion D[m] which is a detection target are set to a low level in the unit period TU for detection, for example.

In this manner, in the present embodiment, for example, the residual vibration signal VR[m] indicating the residual vibration of the diaphragm 14 caused by continuously executing the ejection driving for driving the piezoelectric element PZ by the drive signal COM for ejecting the ink from the nozzle N is used for evaluating the ejection stability. The continuous execution of the ejection driving means, for example, that ejection driving is executed in each of the plurality of consecutive unit periods TU.

The operation of the liquid ejecting apparatus 100 is not limited to the example illustrated in FIG. 6. For example, in FIG. 6, the drive signal COM including one pulse PA for ejecting the ink from the nozzle N is illustrated as an example, and the present disclosure is not limited to such an aspect. For example, the drive signal COM may have a plurality of pulses for ejecting inks for forming dots having different sizes from the nozzle N. For example, in FIG. 6, a case is illustrated as an example in which there is one drive signal COM for ejecting an ink from the nozzle N, and the present disclosure is not limited to such an aspect. For example, the plurality of drive signals COM corresponding to sizes of dots may be used as the drive signal COM for ejecting the ink from the nozzle N. The plurality of drive signals COM may include one or both of the drive signals COM having a minute vibration waveform for preventing thickening of the ink and the drive signal COM having a minute vibration waveform for generating residual vibration for evaluating the ejection state.

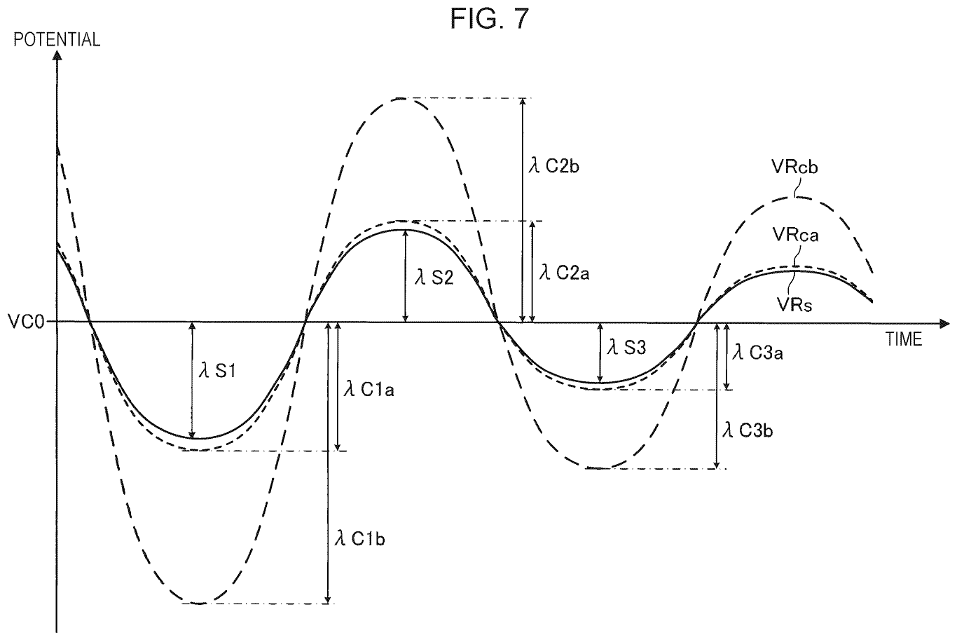

Next, an operation of the analysis portion 3 will be described with reference to FIG. 7.

FIG. 7 is a diagram illustrating an example of a waveform of the residual vibration signal VR. FIG. 7 schematically illustrates the example of the waveform of the residual vibration signal VR indicating residual vibration detected in the unit period TU for detection. A vertical axis of a graph indicates a potential of the residual vibration signal VR, and a horizontal axis indicates a time.

In addition, a potential VC0 indicates a reference potential of the residual vibration signal VR. For example, the potential VC0 may be a potential of the residual vibration signal VR when residual vibration of the diaphragm 14 is attenuated and the residual vibration is settled, or may be an intermediate potential between a potential of a peak at which a waveform of the residual vibration signal VR becomes a mountain and a potential of a peak at which the waveform of the residual vibration signal VR becomes a valley. The peak at which the waveform of the residual vibration signal VR becomes a mountain is a peak at which the potential of the residual vibration signal VR becomes a maximum value, and the peak at which the waveform of the residual vibration signal VR becomes a valley is a peak at which the potential of the residual vibration signal VR becomes a minimum value.

Each of residual vibration signals VRca and VRcb is, for example, the residual vibration signal VR indicating residual vibration of the diaphragm 14 caused by continuously executing ejection driving 10 times. The residual vibration signal VRca is an example of the residual vibration signal VR when the ejection is stable, and the residual vibration signal VRcb is an example of the residual vibration signal VR when the ejection is unstable. In the following, the residual vibration signals VRca and VRcb are also referred to as a residual vibration signal VRc without particular distinction. For example, a residual vibration signal VRs is the residual vibration signal VR indicating residual vibration of the diaphragm 14 caused by executing the ejection driving only one time. The residual vibration signal VRs is used for calculating a threshold value, for example, as compared with the residual vibration signal VRc. Each waveform illustrated in FIG. 7 is a waveform for describing the operation of the analysis portion 3, and does not accurately represent a relationship between the residual vibration of the diaphragm 14 caused by continuously executing the ejection driving 10 times and the residual vibration of the diaphragm 14 caused by executing the ejection driving only one time.

As described above, the residual vibration signal VR indicates a waveform corresponding to the residual vibration of the ejecting portion D as a detection target, that is, the residual vibration of the diaphragm 14. Specifically, the residual vibration signal VR indicates an amplitude corresponding to an amplitude of the residual vibration of the diaphragm 14, a cycle corresponding to a cycle of the residual vibration of the diaphragm 14, and a phase corresponding to a phase of the residual vibration of the diaphragm 14.

In the example illustrated in FIG. 7, for example, the analysis portion 3 specifies an amplitude λS1 of a peak, which is first among a plurality of peaks at which a potential is the maximum value or the minimum value in the residual vibration signal VRs, as an amplitude of a peak which is first in the residual vibration of the diaphragm 14 caused by executing the ejection driving only one time. In addition, the analysis portion 3 respectively specifies an amplitude λS2 of a peak which is second and an amplitude λS3 of a peak which is third in the residual vibration signal VRs, as an amplitude of a peak which is second and an amplitude of a peak which is third in the residual vibration of the diaphragm 14 caused by executing the ejection driving only one time. In the following, the amplitudes λS1, λS2, and λS3 of the residual vibration signal VRs may be collectively referred to as an amplitude λS.

In the same manner, the analysis portion 3 specifies the amplitude λC1 at the peak which is first in the residual vibration signal VRc as the amplitude of the peak which is first in the residual vibration of the diaphragm 14 by continuously executing ejection driving 10 times. In addition, the analysis portion 3 respectively specifies the amplitude λC2 of the peak which is second and the amplitude λC3 of the peak which is third in the residual vibration signal VRc, as the amplitude of the peak which is second and the amplitude of the peak which is third in the residual vibration of the diaphragm 14 by continuously executing the ejection driving 10 times. In the following, the amplitudes λC1, λC2, and λC3 of the residual vibration signal VRc may be collectively referred to as an amplitude λC.

In FIG. 7, in order to distinguish the amplitude λC of the residual vibration signal VRca from the amplitude λC of the residual vibration signal VRcb, an alphabet “a” or “b” is added to the end of each of the reference numerals of the amplitudes λC1, λC2, and λC3. For example, the amplitudes λC1a, λC2a, and λC3a respectively indicate the amplitude λC1 of the peak which is first, the amplitude λC2 of the peak which is second, and the amplitude λC3 of the peak which is third in the residual vibration signal VRca. In addition, the amplitudes λC1b, λC2b, and λC3b respectively indicate the amplitude λC1 of the peak which is first, the amplitude λC2 of the peak which is second, and the amplitude λC3 of the peak which is third in the residual vibration signal VRcb.

When the ejection is stable, as illustrated in the residual vibration signals VRs and VRca, a waveform of the residual vibration signal VRc is a waveform similar to a waveform of the residual vibration signal VRs. That is, when the ejection is unstable, as illustrated in the residual vibration signals VRs and VRcb, the waveform of the residual vibration signal VRc is a waveform that is not similar to the waveform of the residual vibration signal VRs. When the ejection is unstable, a difference between the amplitude λC of the residual vibration signal VRc and the amplitude λS of the residual vibration signal VRs becomes large, which is obtained by the experiment of the inventor. Therefore, in the present embodiment, when at least one of a difference between the amplitude λS1 and the amplitude λC1, a difference between the amplitude λS2 and the amplitude λC2, and a difference between the amplitude λS3 and the amplitude λC3 is equal to or more than a predetermined value, it is assumed that the waveform of the residual vibration signal VRc is not similar to the waveform of the residual vibration signal VRs. The predetermined value is determined, for example, for each peak of the residual vibration signal VR.

The amplitude λC1 is an example of an “amplitude of first peak”, and the amplitude λC2 is an example of an “amplitude of second peak”. In addition, the amplitude λS1 is an example of an “amplitude of third peak”, and the amplitude λS2 is an example of an “amplitude of fourth peak”.

For example, the analysis portion 3 specifies a cycle of the residual vibration signal VR as a cycle of the residual vibration of the diaphragm 14, and specifies a phase of the residual vibration signal VR as a phase of the residual vibration of the diaphragm 14. Here, in the present embodiment, a case is assumed in which an amplitude of the residual vibration of the diaphragm 14 is used for evaluating the ejection stability among the amplitude, the cycle, and the phase. In this case, the analysis portion 3 may not specify the cycle and the phase of the residual vibration signal VRc. In the present embodiment, a case is assumed in which among the amplitude, the cycle, and the phase of the residual vibration of the diaphragm 14, the cycle is used for evaluating the ejection state of the nozzle N. In this case, the analysis portion 3 may not specify the phase of the residual vibration signal VRs.

The analysis method of the residual vibration is not limited to the example described above, and a known method can be adopted.

The analysis portion 3 outputs, for example, an analysis result of the residual vibration, that is, the residual vibration information Vinf indicating the analysis result of the residual vibration signal VR to the control unit 4. For example, the analysis portion 3 outputs the residual vibration information Vinf respectively indicating the amplitudes λC1, λC2, and λC3 of the residual vibration signal VRc to the control unit 4, as an analysis result of the residual vibration of the diaphragm 14 caused by continuously executing the ejection driving 10 times. For example, the analysis portion 3 outputs the amplitudes λS1, λS2, and λS3 of the residual vibration signal VRs and the residual vibration information Vinf respectively indicating the cycles, as the analysis result of the residual vibration of the diaphragm 14 caused by executing the ejection driving only one time, to the control unit 4.

Next, an operation of the liquid ejecting apparatus 100 when evaluating an ejection stability will be described with reference to FIG. 8.

FIG. 8 is a flowchart illustrating an example of the operation of the liquid ejecting apparatus 100 when evaluating the ejection stability of the ink from the nozzle N. A timing at which the operation illustrated in FIG. 8 is executed is not particularly limited, and it is preferable to be executed when the liquid ejecting apparatus 100 is used for the first time or when a use condition of the liquid ejecting apparatus 100 is changed by a change in type of ink to be used. The use condition of the liquid ejecting apparatus 100 also includes a use condition of the liquid ejecting head 1. The operation illustrated in FIG. 8 is executed on each of the plurality of liquid ejecting heads 1, for example. In addition, in the operation illustrated in FIG. 8, a case is assumed in which an ejection state of the nozzle Nis evaluated before the ejection stability is evaluated.

The control unit 4 functions as the evaluation control portion 40 in each step from step S100 to step S250 illustrated in FIG. 8. A process in step S100 is executed, for example, in a state in which the pressure chamber CV is filled with an ink to be used by a user of the liquid ejecting apparatus 100. That is, after the pressure chamber CV is filled with the ink to be used by the user, the process in step S100 is executed. The process of filling the pressure chamber CV with the ink may be executed by the evaluation control portion 40, or may be executed by a processing portion other than the evaluation control portion 40. The user is, for example, a user of the liquid ejecting apparatus 100. Further, when a manufacturer and the user of the liquid ejecting apparatus 100 are the same, the manufacturer of the liquid ejecting apparatus 100 may be regarded as the user.

First, in step S100, the evaluation control portion 40 executes ejection driving one time. For example, the evaluation control portion 40 controls the liquid ejecting head 1 such that the piezoelectric element PZ of the ejecting portion D, which is a detection target, is driven by the drive signal COM for ejecting an ink from the nozzle N. Therefore, the piezoelectric element PZ of the ejecting portion D as a detection target is driven such that the ink is ejected from the nozzle N of the ejecting portion D as a detection target.

Next, in step S110, the evaluation control portion 40 detects residual vibration of the ejecting portion D, which is a detection target. For example, the evaluation control portion 40 causes the detection circuit 19 to detect the residual vibration from the piezoelectric element PZ of the ejecting portion D, which is a detection target, in the next unit period TU after the unit period TU in which the ejection driving is executed. Therefore, the residual vibration of the diaphragm 14 caused by executing the ejection driving only one time is detected by the detection circuit 19. The residual vibration detected by the detection circuit 19 is analyzed by the analysis portion 3. Therefore, for example, the amplitudes λS1, λS2, and λS3 of the residual vibration signal VRs and a cycle of the residual vibration signal VRs are respectively specified, as an analysis result of the residual vibration of the diaphragm 14 caused by executing the ejection driving only one time. The evaluation control portion 40 acquires the residual vibration information Vinf indicating the analysis result of the residual vibration detected by the detection circuit 19 from the analysis portion 3. The residual vibration detected in step S110 is an example of “second residual vibration”.

Next, in step S120, the evaluation control portion 40 executes evaluation on an ejection state of the nozzle N. For example, when the amplitude λS1 of the residual vibration signal VRs is equal to or more than a predetermined amplitude and the cycle of the residual vibration signal VRs is equal to or more than a first predetermined value and equal to or less than a second predetermined value, the evaluation control portion 40 evaluates that the ejection state of the nozzle N included in the detection target ejecting portion D is normal. That is, when the amplitude λS1 of the residual vibration signal VRs is less than the predetermined amplitude or the cycle of the residual vibration signal VRs is out of a range of the first predetermined value or more and the second predetermined value or less, the evaluation control portion 40 evaluates that the ejection state of the nozzle Nis abnormal.

Here, the first predetermined value is a value for indicating a boundary between a time length of one cycle of residual vibration when the ejection state of the nozzle N is normal and a time length of one cycle of the residual vibration when air bubbles are mixed in the pressure chamber CV. The second predetermined value is a value for indicating a boundary between a time length of one cycle of residual vibration when the ejection state of the nozzle Nis normal and a time length of one cycle of the residual vibration when a foreign matter adheres to the vicinity of the nozzle N. In addition, a third predetermined value to be described below is a value for indicating a boundary between a time length of one cycle of residual vibration when a foreign matter adheres to the vicinity of the nozzle N and a time length of one cycle of the residual vibration when the ink in the pressure chamber CV is thickened. For example, the second predetermined value is more than the first predetermined value and less than the third predetermined value.

For example, when the amplitude λS1 of the residual vibration signal VRs is equal to or more than the predetermined amplitude and the cycle of the residual vibration signal VRs is less than the first predetermined value, the evaluation control portion 40 specifies that the ejection state of the nozzle N is abnormal due to mixing of air bubbles into the nozzle N. In addition, when the amplitude λS1 of the residual vibration signal VRs is equal to or more than the predetermined amplitude and the cycle of the residual vibration signal VRs is more than the second predetermined value and equal to or less than the third predetermined value, the evaluation control portion 40 specifies that the ejection state of the nozzle Nis abnormal due to a leakage of the ink from the nozzle N. Further, when the amplitude λS1 of the residual vibration signal VRs is equal to or more than the predetermined amplitude and the cycle of the residual vibration signal VRs is more than the third predetermined value, the evaluation control portion 40 specifies that the ejection state of the nozzle N is abnormal due to thickening of the ink in the nozzle N. Further, when the amplitude λS1 of the residual vibration signal VRs is less than the predetermined amplitude, the evaluation control portion 40 specifies that the ejection state of the nozzle N has an abnormality other than the abnormality described above.

The method of determining the ejection state is not limited to the example described above, and a known method can be adopted. The evaluation control portion 40 executes the process in step S120, and then shifts the process to step S130.

In step S130, the evaluation control portion 40 determines whether or not the ejection state of the nozzle Nis normal. For example, when it is evaluated that the ejection state of the nozzle N is normal in step S120, the evaluation control portion 40 determines that the ejection state of the nozzle N is normal. For example, when it is evaluated that the ejection state of the nozzle N is abnormal in step S120, the evaluation control portion 40 determines that the ejection state of the nozzle N is not normal.

When a result of the determination in step S130 is negative, the evaluation control portion 40 executes a recovery process of the ejection state in step S140, then returns to step S100 after a predetermined time elapses, and the same process is performed again. For example, the evaluation control portion 40 executes a recovery process of recovering the ejection state of the nozzle N to a normal state, based on a type of the abnormality specified in step S120. As the recovery process of the ejection state, a known process can be adopted. Here, a case is described as an example in which a series of processes in step S100 to step S140 are repeated until it is determined that the ejection state is normal in step S130. Meanwhile, when it is determined that the ejection state is abnormal in step S130 even after the series of processes are repeated a predetermined number of times, the operation of the liquid ejecting apparatus 100 may be stopped and the user may be notified.

On the other hand, when the result of the determination in step S130 is affirmative, the evaluation control portion 40 shifts the process to step S200.

In step S200, the evaluation control portion 40 sets a waveform of the drive signal COM to be used in step S210. For example, the evaluation control portion 40 sets the waveform of the drive signal COM used in step S100 as the waveform of the drive signal COM to be used in step S210. For example, when a series of processes in step S200 to step S250 are repeated, the evaluation control portion 40 sets the waveform of the drive signal COM used in step S100 as the waveform of the drive signal COM to be used in step S210, in step S200 at a first time. In steps S200 at a second time and subsequent times, the evaluation control portion 40 sets a waveform different from the waveform set in previous step S200 as the waveform of the drive signal COM to be used in step S210. For example, the evaluation control portion 40 sets the length TA of the waveform element Pa4 to a length different from the length set in previous step S200.

The drive signal COM of which the waveform is set in step S200 is an example of a “drive signal candidate”. The evaluation control portion 40 executes the process in step S200, and then shifts the process to step S210.

In step S210, the evaluation control portion 40 continuously executes the ejection driving 10 times. For example, the evaluation control portion 40 controls the liquid ejecting head 1 with the drive signal COM having the waveform set in step S200 such that the piezoelectric element PZ of the ejecting portion D, which is a detection target, is driven in each of the 10 consecutive unit periods TU. Therefore, the ejection driving for ejecting the ink from the nozzle N of the ejecting portion D, which is a detection target, is continuously executed 10 times.

Next, in step S220, the evaluation control portion 40 detects residual vibration of the ejecting portion D, which is a detection target, immediately after the ejection driving is continuously performed 10 times in step S210. For example, the evaluation control portion 40 causes the detection circuit 19 to detect the residual vibration from the piezoelectric element PZ of the ejecting portion D, which is a detection target, in the next unit period TU after the 10 consecutive unit periods TU in which the ejection driving is executed. Therefore, the residual vibration of the diaphragm 14 caused by continuously executing the ejection driving 10 times is detected by the detection circuit 19. The residual vibration detected by the detection circuit 19 is analyzed by the analysis portion 3. Therefore, for example, the amplitudes λC1, λC2, and λC3 of the residual vibration signal VRc are respectively specified as an analysis result of the residual vibration of the diaphragm 14 caused by continuously executing the ejection driving 10 times. The evaluation control portion 40 acquires the residual vibration information Vinf indicating the analysis result of the residual vibration detected by the detection circuit 19 from the analysis portion 3. The residual vibration detected in step S220 is an example of “first residual vibration”.

Next, in step S230, the evaluation control portion 40 executes evaluation on an ejection stability. In the process in step S230, that is, by evaluating the stability, it is determined whether the ejection of the ink from the nozzle Nis stable or unstable when the piezoelectric element PZ is driven by the drive signal COM having the waveform set in step S200. Details of the evaluation on the stability will be described with reference to FIG. 9 which will be described below.

Next, in step S240, the evaluation control portion 40 stores an evaluation result of the ejection stability. For example, the evaluation control portion 40 stores the evaluation result of the ejection stability in the storage unit 5 in association with the waveform drive signal COM set in step S200.

Next, in step S250, the evaluation control portion 40 determines whether or not to change the waveform of the drive signal COM. That is, the evaluation control portion 40 determines whether or not to execute a series of processes in step S210 to step S230 again by changing the waveform of the drive signal COM.

For example, when the result of the stability evaluation executed in step S230 indicates that the ejection of the ink is unstable, the evaluation control portion 40 may determine that the waveform of the drive signal COM is to be changed. Alternatively, when there is a drive signal candidate not used in step S210, among a plurality of drive signal candidates including the drive signal COM used in step S100, the evaluation control portion 40 may determine that the waveform of the drive signal COM is to be changed. For example, the waveforms of the plurality of drive signal candidates are determined based on an ejection characteristic of the ink of the ejecting portion D and the like, and are the same as each other, except for the length TA of the waveform element Pa4 and the length TB of the waveform element Pa5.

When a result of the determination in step S250 is affirmative, the evaluation control portion 40 returns the process to step S200. On the other hand, when the result of the determination in step S250 is negative, the evaluation control portion 40 ends the operation illustrated in FIG. 8.

In FIG. 8, a case is illustrated as an example in which the length TA of the waveform element Pa4 is changed by repeating the series of processes in step S200 to step S250, and the present disclosure is not limited to such an aspect. For example, by repeating the series of processes in step S200 to step S250, instead of the length TA of the waveform element Pa4, or in addition to the length TA of the waveform element Pa4, a parameter other than the length TA of the waveform element Pa4 may be changed. The parameter other than the length TA of the waveform element Pa4 is, for example, an inclination of the waveform element Pa1, a length of the waveform element Pa2, an inclination of the waveform element Pa3, an inclination of the waveform element Pa5, the potential VHa, the potential VLa, or the like.

A series of processes in step S100 to step S120 is an example of “second evaluation”, and the series of processes in step S210 to step S230 is an example of “first evaluation”.

Next, an example of stability evaluation executed in step S230 will be described with reference to FIG. 9.

FIG. 9 is a flowchart illustrating an example of the stability evaluation illustrated in FIG. 8. A series of processes in step S232 to step S239 illustrated in FIG. 9 corresponds to the process in step S230 illustrated in FIG. 8. For example, the process in step S232 is executed after the process in step S220 illustrated in FIG. 8 is executed, and the process in step S240 illustrated in FIG. 8 is executed after the process in step S238 or the process in step S239 is executed. The control unit 4 functions as the evaluation control portion 40 in each step from step S232 to step S239 illustrated in FIG. 9.

In the operation illustrated in FIG. 9, the amplitudes λS1, λS2, and λS3 of the residual vibration signal VRs specified by the process in step S110 illustrated in FIG. 8, and the amplitudes λC1, λC2, and λC3 of the residual vibration signal VRc specified by the process in step S220 illustrated in FIG. 8 are used.

First, in step S232, the evaluation control portion 40 determines whether or not the amplitude λC1 is equal to or less than 1.3 times the amplitude λS1. That is, the evaluation control portion 40 determines whether or not an amplitude of a peak which is first in residual vibration of the diaphragm 14 caused by the ejection driving continuously executed 10 times is equal to or less than 1.3 times an amplitude of a peak which is first in residual vibration of the diaphragm 14 caused by executing the ejection driving only one time. A value obtained by multiplying the amplitude λS1 by 1.3, that is, a value obtained by multiplying the amplitude λS1 by a coefficient “1.3” is an example of a “first threshold value”. In addition, the coefficient “1.3” multiplied by the amplitude λS1 is an example of a “first coefficient”. The “first coefficient” is not limited to “1.3”.

When a result of the determination in step S232 is negative, the evaluation control portion 40 determines that the ink ejection is unstable in step S239, and then shifts the process to step S240 illustrated in FIG. 8. That is, the evaluation control portion 40 ends the operation illustrated in FIG. 9 after executing the process in step S239. In this manner, when the amplitude λC1 of the peak which is first in the residual vibration signal VRc is more than 1.3 times the amplitude λS1 of the peak which is first in the residual vibration signal VRs, the evaluation control portion 40 determines that the ejection of the ink is unstable.

On the other hand, when the result of the determination in step S232 is affirmative, the evaluation control portion 40 shifts the process to step S234.

In step S234, the evaluation control portion 40 determines whether or not the amplitude λC2 is equal to or less than 1.2 times the amplitude λS2. That is, the evaluation control portion 40 determines whether or not an amplitude of a peak which is second in the residual vibration of the diaphragm 14 caused by continuously executing the ejection driving 10 times is 1.2 times or less an amplitude of a peak which is second in the residual vibration of the diaphragm 14 caused by executing the ejection driving only one time. A value obtained by multiplying the amplitude λS2 by 1.2, that is, a value obtained by multiplying the amplitude λS2 by a coefficient “1.2” is an example of a “second threshold value”. In addition, the coefficient “1.2” multiplied by the amplitude λS2 is an example of a “second coefficient”. The “second coefficient” is not limited to “1.2”.

When a result of the determination in step S234 is negative, the evaluation control portion 40 determines that the ink ejection is unstable in step S239, and then shifts the process to step S240 illustrated in FIG. 8. In this manner, the evaluation control portion 40 determines that the ejection of the ink is unstable when the amplitude λC2 of the peak which is second in the residual vibration signal VRc is more than 1.2 times the amplitude λS2 of the peak which is second in the residual vibration signal VRs.

On the other hand, when the result of the determination in step S234 is affirmative, the evaluation control portion 40 shifts the process to step S236.

In step S236, the evaluation control portion 40 determines whether or not the amplitude λC3 is equal to or less than 1.1 times the amplitude λS3. That is, the evaluation control portion 40 determines whether or not an amplitude of a peak which is third in the residual vibration of the diaphragm 14 caused by continuously executing the ejection driving 10 times is 1.1 times or less an amplitude of a peak which is third in the residual vibration of the diaphragm 14 caused by executing the ejection driving only one time. The coefficient multiplied by the amplitude λS3 is not limited to “1.1”.

When a result of the determination in step S236 is negative, the evaluation control portion 40 determines that the ink ejection is unstable in step S239, and then shifts the process to step S240 illustrated in FIG. 8. In this manner, when the amplitude λC3 of the peak which is third in the residual vibration signal VRc is more than 1.1 times the amplitude λS2 of the peak which is third in the residual vibration signal VRs, the evaluation control portion 40 determines that the ejection of the ink is unstable.

On the other hand, when the result of the determination in step S236 is affirmative, the evaluation control portion 40 shifts the process to step S238.

In step S238, the evaluation control portion 40 determines that the ink ejection is stable. That is, when the results of the determination in steps S232, S234, and S236 are all affirmative, the evaluation control portion 40 determines that the ink ejection is stable. Then, the control unit 4 executes the process in step S238, and then shifts the process to step S240 illustrated in FIG. 8. That is, the evaluation control portion 40 ends the operation illustrated in FIG. 9 after executing the process in step S238.

In this manner, the drive signal COM with which the ink ejection is stable and the drive signal COM with which the ink ejection is unstable are specified by the stability evaluation illustrated in FIG. 9.

In addition, in the evaluation on the stability illustrated in FIG. 9, a value based on the amplitude λS of the residual vibration signal VRs is used as a threshold value to be compared to the amplitude λC of the residual vibration signal VRc. Specifically, the first threshold value to be compared with the amplitude λC1 is a value based on the amplitude λS1, the second threshold value to be compared with the amplitude λC2 is a value based on the amplitude λS2, and the third threshold value to be compared with the amplitude λC3 is a value based on the amplitude λS3. In the present embodiment, the value based on the amplitude λS of the residual vibration signal VRs is used as a threshold value to be compared with the amplitude λC of the residual vibration signal VRc. Therefore, a threshold value according to a use condition of the liquid ejecting head 1, such as a type of the used ink can be used. Therefore, in the present embodiment, the ejection stability can be evaluated with high accuracy.

In addition, in the stability evaluation illustrated in FIG. 9, the first threshold value described above is a value obtained by multiplying the amplitude λS1 and the first coefficient “1.3”, the second threshold value is a value obtained by multiplying the amplitude λS2 and the second coefficient “1.2”, and the third threshold value is a value obtained by multiplying the amplitude λS3 and the third coefficient “1.1”. The second coefficient is less than the first coefficient, and the third coefficient is less than the second coefficient. Here, since the residual vibration is attenuated, among the amplitudes of the plurality of peaks of the residual vibration signal VR, the amplitude of the latter half peak tends to be less than the amplitude of the former half peak. As a value of actual data (peak amplitude) is increased, a deviation of the measurement value is also increased when a certain measurement error occurs. Therefore, by setting the first coefficient to be more than the second coefficient and setting the second coefficient to be more than the third coefficient, and allowing the deviation to be larger in the former half in which the amplitude of the peak is large, the ejection stability can be evaluated with high accuracy. Meanwhile, a relationship between the first coefficient, the second coefficient, and the third coefficient is not limited to the example described above. For example, the first coefficient, the second coefficient, and the third coefficient may have the same value as each other.

The operation of the liquid ejecting apparatus 100 when evaluating the ejection stability is not limited to the examples illustrated in FIGS. 8 and 9. For example, in the operation illustrated in FIG. 9, the evaluation control portion 40 may also determine a lower limit of the amplitude λC of the residual vibration signal VRc. Specifically, the evaluation control portion 40 may determine whether or not the amplitude λC1 is equal to or more than 0.7 times the amplitude λS1 before executing the process in step S232. When the amplitude λC1 is less than 0.7 times the amplitude λS1, the evaluation control portion 40 may determine that the ejection of the ink is unstable in step S239, and then may shift the process to step S240 illustrated in FIG. 8. That is, in this aspect, the process in step S232 is executed when the amplitude λC1 is 0.7 times or more the amplitude λS1. A threshold value indicating the lower limit of the amplitude λC is not limited to 0.7 times the amplitude λS1. In addition, for example, in each of steps S232, S234, and S236, the lower limit of the amplitude λC may be set.

In addition, for example, in the operation illustrated in FIG. 9, one process of the process in step S232, the process in step S234, and the process in step S236 may be omitted. For example, in an aspect in which the process in step S236 is omitted, the evaluation control portion 40 determines that the ejection is stable when the amplitude λC1 is equal to or less than 1.3 times the amplitude λS1 and the amplitude λC2 is equal to or less than 1.2 times the amplitude λS2.

In addition, for example, in the operation illustrated in FIG. 9, two processes of the process in step S232, the process in step S234, and the process in step S236 may be omitted. That is, the evaluation control portion 40 may evaluate the ejection stability of the ink from the nozzle N based on the amplitude of at least one peak among a plurality of peaks of the residual vibration of the diaphragm 14 caused by continuously executing the ejection driving 10 times.

In addition, for example, the threshold value to be compared with the amplitude λC of the residual vibration signal VRc may be a predetermined amplitude value. That is, each of the first threshold value to be compared with the amplitude λC1, the second threshold value to be compared with the amplitude λC2, and the third threshold value to be compared with the amplitude λC3 may be a predetermined fixed value. In the present aspect, it is preferable that the second threshold value is less than the first threshold value, and the third threshold value is less than the second threshold value. In the present aspect, the series of processes in step S100 to step S140 illustrated in FIG. 8 may be omitted, or may be executed after the ejection stability is evaluated.

In addition, in the operation illustrated in FIG. 9, instead of the amplitude λC of the residual vibration signal VRc, or in addition to the amplitude λC of the residual vibration signal VRc, one or both of the cycle and the phase of the residual vibration signal VRc may be used for evaluating the ejection stability. For example, the evaluation control portion 40 may determine that the ejection is unstable when the cycle of the residual vibration signal VRc is out of a range of 0.8 times or more and 1.2 times or less the cycle of the residual vibration signal VRs. In the same manner, when the phase of the residual vibration signal VRc is out of a range of 0.8 times or more and 1.2 times or less the phase of the residual vibration signal VRs, the evaluation control portion 40 may determine that the ejection is unstable. The lower limit and the upper limit of the cycle compared with the cycle of the residual vibration signal VRc, and the lower limit and the upper limit of the phase compared with the phase of the residual vibration signal VRc are not limited to the example described above.

For example, the evaluation control portion 40 may determine the waveform of the drive signal COM based on the result of evaluating the ejection stability. For example, the evaluation control portion 40 may adopt the drive signal COM with which it is determined that the ejection is stable in the stability evaluation illustrated in FIG. 9 as the drive signal COM to be used in the actual printing process. That is, the evaluation control portion 40 may determine the waveform of the drive signal COM based on the first residual vibration detected by the detection circuit 19 as the residual vibration of the diaphragm 14 caused by continuously executing the ejection driving. In this manner, in the present embodiment, the waveform of the drive signal COM can be easily determined to be an appropriate waveform with which the ink ejection is stable, based on the first residual vibration. In addition, for example, when a plurality of candidates of the drive signal COM are determined to be stable in ejection, the evaluation control portion 40 may adopt, as the drive signal COM, a candidate of which the waveform of the residual vibration signal VRc coincides with or is most similar to the waveform of the residual vibration signal VRs among the plurality of candidates. In the present embodiment, the ejection of the ink from the nozzle N can be easily prevented from being unstable, by determining the waveform of the drive signal COM based on the evaluation result of the ejection stability.

As described above, in the present embodiment, the liquid ejecting apparatus 100 includes the liquid ejecting head 1 including the nozzle N that ejects inks, the piezoelectric element PZ corresponding to the nozzle N, the diaphragm 14 that vibrates by driving the piezoelectric element PZ, and the detection circuit 19 that detects residual vibration of the diaphragm 14 caused by driving the piezoelectric element PZ, and the evaluation control portion 40 that executes first evaluation for evaluating an ejection stability of the ink from the nozzle N. In the first evaluation, the evaluation control portion 40 causes the detection circuit 19 to detect the residual vibration caused by continuous execution of ejection driving for driving the piezoelectric element PZ by the drive signal COM for ejecting the ink from the nozzle N as first residual vibration, and evaluates the ejection stability of the ink from the nozzle N based on the first residual vibration detected by the detection circuit 19. In addition, the evaluation control portion 40 may determine a waveform of the drive signal COM based on the first residual vibration detected by the detection circuit 19.

In this manner, in the present embodiment, the evaluation control portion 40 evaluates the ejection stability of the ink based on the first residual vibration caused by continuously executing the ejection driving for driving the piezoelectric element PZ by the drive signal COM for ejecting the ink from the nozzle N. Therefore, in the present embodiment, the ejection stability of the ink from the nozzle N can be appropriately and easily evaluated, without requiring an external element such as an imaging environment. In the present embodiment, the evaluation control portion 40 determines the waveform of the drive signal COM based on the first residual vibration, and thus the waveform of the drive signal COM for driving the piezoelectric element PZ can be appropriately and easily determined.

In the present embodiment, the evaluation control portion 40 may evaluate the ejection stability of the ink from the nozzle N based on an amplitude of at least one peak of a plurality of peaks of the first residual vibration in the first evaluation. In this case, the ejection stability of the ink from the nozzle N can be appropriately and easily evaluated, without specifying a cycle and a phase of the first residual vibration.

In the present embodiment, in the first evaluation, the evaluation control portion 40 may determine that the ejection stability of the ink from the nozzle N is unstable when an amplitude of a first peak, which is first among the plurality of peaks of the first residual vibration, is more than a first threshold value. In this case as well, the ejection stability of the ink from the nozzle N can be appropriately and easily evaluated. In addition, when it is determined that the ejection of the ink is unstable based on the amplitude of the first peak among the plurality of peaks of the first residual vibration, it is not necessary to refer to the amplitudes of the other peaks, and thus an increase in load on the evaluation of the ejection stability can be prevented.

In the present embodiment, in the first evaluation, the evaluation control portion 40 may determine that the ejection of the ink from the nozzle Nis unstable when an amplitude of a second peak, which is second among the plurality of peaks of the first residual vibration, is more than a second threshold value. In this case, since the ejection stability is evaluated based on the plurality of peaks of the first residual vibration, the ejection stability can be evaluated with high accuracy.

In the present embodiment, in the first evaluation, the evaluation control portion 40 may determine that the ejection of the ink from the nozzle Nis stable when the amplitude of the first peak is equal to or less than the first threshold value and the amplitude of the second peak is equal to or less than the second threshold value. In this case as well, the ejection stability can be evaluated with high accuracy.

In the present embodiment, the evaluation control portion 40 may cause the detection circuit 19 to detect residual vibration caused by executing the ejection driving only one time as second residual vibration, and use a value based on an amplitude of a third peak, which is first among a plurality of peaks of the second residual vibration, as the first threshold value. In this manner, in the present aspect, a value based on an amplitude of a peak which is first in the second residual vibration caused by executing the ejection driving only one time is used as the first threshold value to be compared with the amplitude of the peak which is first of the first residual vibration. That is, in the present aspect, a threshold value according to a use condition of the liquid ejecting head 1 is used as the first threshold value. As a result, in the present aspect, the ejection stability can be accurately evaluated, in accordance with the use condition of the liquid ejecting head 1.

In the present embodiment, in the first evaluation, the evaluation control portion 40 causes the detection circuit 19 to detect the residual vibration caused by executing the ejection driving only one time as the second residual vibration, and uses a value obtained by multiplying the amplitude of the third peak, which is first among the plurality of peaks of the second residual vibration, and the first coefficient as the first threshold value, and a value obtained by multiplying an amplitude of a fourth peak, which is second among the plurality of peaks of the second residual vibration, and the second coefficient less than the first coefficient as the second threshold value. In the present aspect as well, the ejection stability can be accurately evaluated, in accordance with the use condition of the liquid ejecting head 1. In the present aspect, the ejection stability can be evaluated with higher accuracy, as compared with a case where the ejection stability is evaluated based on only the amplitude of the first peak which is first of the first residual vibration.

In the present embodiment, the evaluation control portion 40 may cause the detection circuit 19 to detect the residual vibration caused by executing the ejection driving only one time as the second residual vibration, and may further execute the second evaluation of evaluating the ejection state of the nozzle N based on the second residual vibration detected by the detection circuit 19. In this manner, in the present aspect, the ejection state of the nozzle N can be appropriately and easily evaluated by using the second residual vibration.

In the present embodiment, the evaluation control portion 40 may execute the first evaluation for each of the plurality of drive signal candidates having different waveforms for ejecting the ink from the nozzle N, by using one drive signal candidate among the plurality of drive signal candidates as the drive signal COM, and may specify A drive signal candidate with which the ejection of the ink from the nozzle Nis stable and a drive signal candidate with which the ejection of the ink from the nozzle N is unstable, from the plurality of drive signal candidates. In the present aspect, the waveform of the drive signal candidate with which the ink is stably ejected from the nozzle N is determined as the waveform of the drive signal COM. Thus, the waveform of the drive signal COM for driving the piezoelectric element PZ can be appropriately and easily determined.

In the present embodiment, the evaluation control portion 40 may cause the detection circuit 19 to detect the residual vibration caused by continuously executing the ejection driving 10 times or more, as the first residual vibration in the first evaluation. In the present aspect as well, the ejection stability of the ink from the nozzle N can be appropriately and easily evaluated.

### 2. Modification Example

Each embodiment above can be variously modified. A specific aspect of the modification will be described below. Two or more aspects selected in any manner from the following examples can be appropriately combined with each other within a range not inconsistent with each other. In addition, in the modification examples described below, elements having the same effects and functions as those of the embodiment will be given the reference numerals used in the description above, and each detailed description thereof will be appropriately omitted.

### First Modification Example

In the embodiment described above, the drive signal COM for detecting an ejection abnormality of the nozzle N may be supplied from the drive signal generation unit 2 to the liquid ejecting head 1. In the present modification example, an ejection state of the nozzle N can be evaluated by driving the piezoelectric element PZ with the drive signal COM for detecting the ejection abnormality of the nozzle N.

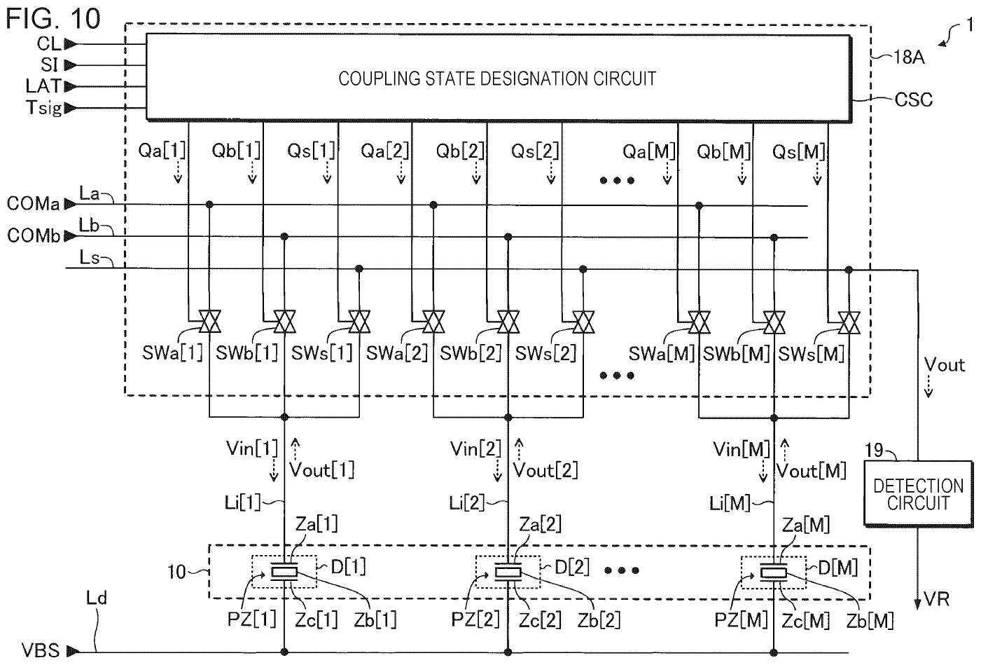

FIG. 10 is a block diagram illustrating an example of a configuration of the liquid ejecting head 1 according to a first modification example. The liquid ejecting head 1 illustrated in FIG. 10 has the same manner as the liquid ejecting head 1 illustrated in FIG. 5, except that a drive signal COMb for detecting an ejection abnormality of the nozzle N is supplied from the drive signal generation unit 2. Specifically, the liquid ejecting head 1 illustrated in FIG. 10 has the same manner as the liquid ejecting head 1 illustrated in FIG. 5, except that the liquid ejecting head 1 illustrated in FIG. 10 includes a switching circuit 18A instead of the switching circuit 18 illustrated in FIG. 5. The drive signal COMa illustrated in FIG. 10 has the same manner as the drive signal COM illustrated in FIG. 6.

The switching circuit 18A has the same manner as the switching circuit 18, except that a wiring Lb through which the drive signal COMb is supplied from the drive signal generation unit 2 and M switches SWb[1] to SWb[M] corresponding to the M ejecting portions D[1] to D[M] on a one-to-one basis are added to the switching circuit 18 illustrated in FIG. 5. Meanwhile, the coupling state designation circuit CSC generates coupling state designation signals Qa[m], Qb[m], and Qs[m], based on at least some of the print signal SI, a latch signal LAT, and a period designation signal Tsig, which are supplied from the control unit 4.

The switch SWb[m] switches conduction and non-conduction between the wiring Lb and the individual electrode Za[m] of the piezoelectric element PZ[m] provided in the ejecting portion D[m], based on the coupling state designation signal Qb[m]. That is, the switch SWb[m] switches conduction and non-conduction between the wiring Lb and the wiring Li[m] coupled to the individual electrode Za[m], based on the coupling state designation signal Qb[m]. In the present modification example, the switch SWb[m] is turned on when the coupling state designation signal Qb[m] is at a high level, and is turned off when the coupling state designation signal Qb[m] is at a low level. When the switch SWb[m] is turned on, the drive signal COMb supplied to the wiring Lb is supplied to the individual electrode Za[m] of the ejecting portion D[m] as the individual drive signal Vin[m] via the wiring Li[m].

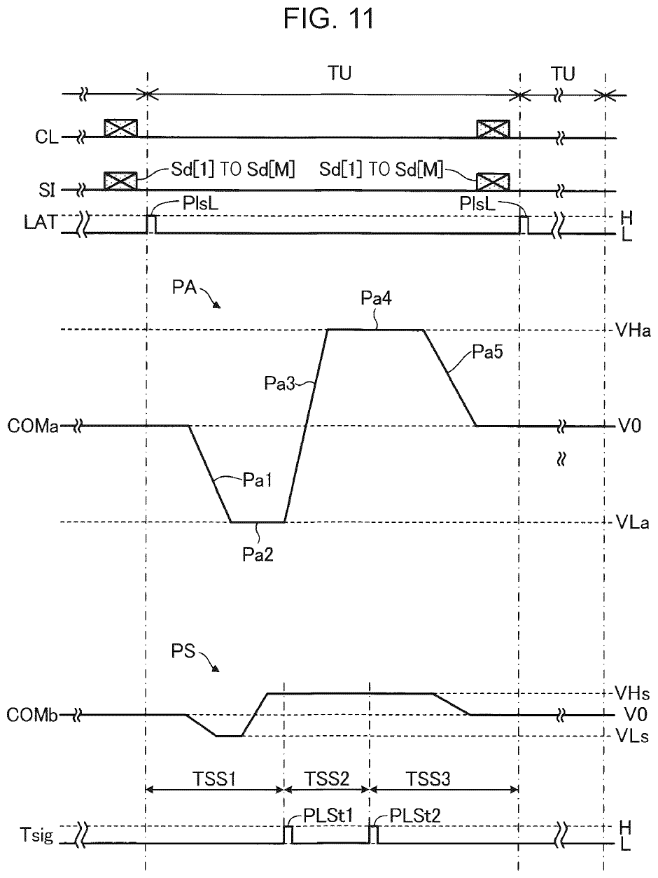

Next, an operation of the liquid ejecting apparatus 100 according to the first modification example will be described with reference to FIG. 11.

FIG. 11 is a timing chart illustrating an example of the operation of the liquid ejecting apparatus 100 according to the first modification example. The operation of the coupling state designation circuit CSC or the like when a driving mode as the ejecting portion D that forms dots, the ejecting portion D that does not form the dots, and the ejecting portion D as a detection target when evaluating an ejection stability is designated by the individual designation signal Sd[m] has the same manner as the operation described in FIG. 6. Therefore, in FIG. 11, the operation of the coupling state designation circuit CSC or the like when the driving mode as the ejecting portion D, which is an ejection abnormality detection target of the nozzle N, is designated by the individual designation signal Sd[m] will be described.

For example, the drive signal generation unit 2 outputs the drive signal COMb having a pulse PS. The pulse PS is a waveform in which a potential of the drive signal COMb is changed from the potential VO and returns to the potential V0, via a potential VLs less than the potential VO and a potential VHs more than the potential V0. In the present modification example, the pulse PS is determined such that a potential difference between the potential VHS, which is the highest potential of the pulse PS, and the potential VLS, which is the lowest potential of the pulse PS, is less than a potential difference between the potential VHa, which is the highest potential of the pulse PA, and the potential VLa, which is the lowest potential of the pulse PA. Specifically, when the drive signal COMb having the pulse PS is supplied to the ejecting portion D[m], a waveform of the pulse PS is determined to drive the ejecting portion D[m] to such an extent that an ink is not ejected from the ejecting portion D[m]. As described above, the potential of the pulse PS at the start and the end is set to the potential V0.

The control unit 4 outputs the period designation signal Tsig having a pulse PLSt1 and a pulse PLSt2. Therefore, the control unit 4 divides the unit period TU into a control period TSS1 from a start of the pulse PlsL to a start of the pulse PLSt1, a control period TSS2 from a start of the pulse PLSt1 to a start of the pulse PLSt2, and a control period TSS3 from a start of the pulse PLSt2 to a start of the next pulse PlsL.

For example, when the individual designation signal Sd[m] designates the ejecting portion D[m] as the ejecting portion D, which is an ejection abnormality detection target, the coupling state designation circuit CSC sets the coupling state designation signal Qa[m] to a low level in the unit period TU. Further, the coupling state designation circuit CSC sets the coupling state designation signal Qb[m] to a high level in the control periods TSS1 and TSS3 and to a low level in the control period TSS2, respectively. Further, the coupling state designation circuit CSC sets the coupling state designation signal Qs[m] to a low level in the control periods TSS1 and TSS3 and to a high level in the control period TSS2, respectively.

In this case, the piezoelectric element PZ[m] included in the ejecting portion D[m] as an ejection abnormality detection target is driven by the pulse PS of the drive signal COMb in the control period TSS1. Specifically, the piezoelectric element PZ[m] is displaced by the pulse PS of the drive signal COMb in the control period TSS1. As a result, vibration is generated in the ejecting portion D[m] as a detection target. The vibration generated in the control period TSS1 remains in the control period TSS2. In the control period TSS2, the potential of the individual electrode Za[m] of the piezoelectric element PZ[m] included in the ejecting portion D[m] as a detection target is changed according to the residual vibration generated in the ejecting portion D[m]. That is, in the control period TSS2, the potential of the individual electrode Za of the piezoelectric element PZ included in the ejecting portion D as a detection target is a potential according to an electromotive force of the piezoelectric element PZ caused by the residual vibration generated in the ejecting portion D as a detection target. The potential of the individual electrode Za is detected as the detection signal Vout in the control period TSS2.

In FIG. 11, a case is illustrated as an example in which the detection signal Vout indicating the residual vibration of the ejecting portion D as an ejection abnormality detection target is generated during a printing process period, and the detection signal Vout may be generated during a period different from the printing process period. That is, the process of detecting the residual vibration of the ejecting portion D, which is an ejection abnormality detection target, may be executed in a period different from the printing process period.

In this manner, in the present modification example, an ejection abnormality of the nozzle N can be detected based on the residual vibration detected by the drive signal COMb. The detection of the ejection abnormality by using the drive signal COMb may be executed before an ejection stability is evaluated, or may be executed after the ejection stability is evaluated. In the present modification example, when the ejection stability is evaluated, the series of processes in step S100 to step S140 illustrated in FIG. 8 may be omitted.

As described above, in the present modification example as well, the same effect as that of the embodiment described above can be obtained. In addition, in the present modification example, an ejection abnormality of the nozzle N can be detected based on the residual vibration detected by the drive signal COMb. That is, in the present modification example, the ejection state of the nozzle N can be evaluated based on the residual vibration detected by the drive signal COMb.

### Second Modification Example

In the embodiment and modification example described above, when a waveform of the drive signal COM used for evaluating an ejection stability is changed, residual vibration of the diaphragm 14 may be detected by executing ejection driving only one time, with the drive signal COM of which the waveform is changed.

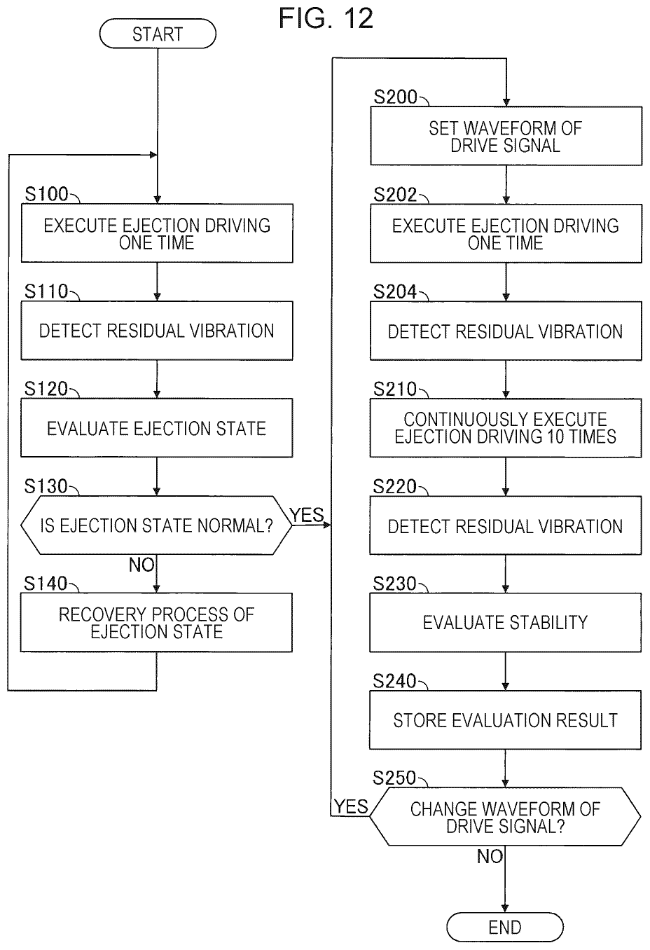

FIG. 12 is a flowchart illustrating an example of an operation of the liquid ejecting apparatus 100 according to a second modification example. The operation illustrated in FIG. 12 has the same manner as the operation illustrated in FIG. 8, except that a series of processes in steps S202 and S204 are executed between steps S200 and S210. The control unit 4 functions as the evaluation control portion 40 in each step of step S202 and step S204.

For example, the evaluation control portion 40 executes the process in step S200, and then shifts the process to step S202.

In step S202, the evaluation control portion 40 executes ejection driving one time, by using the drive signal COM having the waveform set in step S200.

Next, in step S204, the evaluation control portion 40 detects residual vibration of the ejecting portion D, which is a detection target, in the same manner as in step S110. Therefore, for example, the amplitudes λS1, λS2, and λS3 of the residual vibration signal VRs are respectively specified as an analysis result of the residual vibration of the diaphragm 14 caused by executing the ejection driving only one time by using the drive signal COM of the waveform set in step S200. In step S204, a cycle and a phase of the residual vibration signal VRs may not be specified. The evaluation control portion 40 acquires the residual vibration information Vinf indicating the analysis result of the residual vibration detected by the detection circuit 19 from the analysis portion 3. The residual vibration detected in step S204 is an example of “second residual vibration”.

The evaluation control portion 40 executes the process in step S204, and then shifts the process to step S210.

In this manner, in the present modification example, the same drive signal COM is used for detecting the residual vibration of the diaphragm 14 caused by executing the ejection driving only one time and detecting the residual vibration of the diaphragm 14 caused by continuously executing the ejection driving 10 times. Therefore, in the present modification example, a threshold value corresponding to the waveform of the drive signal COM used in step S210 is used as a threshold value to be compared with the amplitude λC of the residual vibration signal VRc.

The operation of the liquid ejecting apparatus 100 according to the present modification example is not limited to the example illustrated in FIG. 12. For example, the series of processes in step S100 to step S140 illustrated in FIG. 12 may be omitted. Further, for example, as the series of processes in step S100 to step S120, ejection abnormality detection using the drive signal COMb described in FIG. 11 may be executed.

As described above, in the present modification example as well, the same effect as that of the embodiment described above can be obtained. Further, in the present modification example, since the threshold value corresponding to the waveform of the drive signal COM is used as the threshold value to be compared with the amplitude λC of the residual vibration signal VRc, an ejection stability can be evaluated with high accuracy.

### Third Modification Example

In the embodiment and modification example described above, waveform information indicating a candidate of the drive signal COM used for evaluating an ejection stability may be stored in advance in a storage unit (not illustrated) of the liquid ejecting head 1 at a time point when the liquid ejecting head 1 is manufactured by a head manufacturer. Alternatively, the waveform information indicating the candidate of the drive signal COM may be stored in the storage unit 5 or the like from the head manufacturer via a network (not illustrated) after the shipment of the liquid ejecting head 1. For example, the waveform information indicating the candidate of the drive signal COM prepared by the head manufacturer is read from the storage unit 5 or the like in which the waveform information indicating the candidate of the drive signal COM is stored when the operation illustrated in FIG. 8 is executed.

As described above, in the present modification example as well, the same effect as that of the embodiment described above can be obtained.

### Fourth Modification Example

In the embodiment and modification example described above, a case is described as an example in which the piezoelectric body Zb is displaced in the Z1 direction by changing a potential of the individual drive signal Vin[m] from a low potential to a high potential, and the present disclosure is not limited to such an aspect. For example, the piezoelectric body Zb that is displaced in the Z1 direction by the potential of the individual drive signal Vin[m] changing from the high potential to the low potential may be used. In this case, for example, the potential of the drive signal COM is changed from the low potential to the high potential in a portion corresponding to an expansion element, and is changed from the high potential to the low potential in a portion corresponding to a contraction element. In the present modification example as well, the same effect as the effect of the embodiment and modification examples described above can be obtained.

### Fifth Modification Example

In the embodiment and the modification example described above, a case is described as an example in which one piezoelectric element PZ, one pressure chamber CV, and one nozzle N are provided for one ejecting portion D, and the present disclosure is not limited to such an aspect. For example, one ejecting portion D may have two piezoelectric elements PZ, two pressure chambers CV, and one nozzle N. As described above, also in the present modification example, the same effect as the effect of the embodiment and modification example described above can be obtained.

### Sixth Modification Example

In the embodiment and the modification example described above, the liquid ejecting apparatus 100 having a serial method in which the carriage 91 at which the liquid ejecting head 1 is mounted is reciprocated in the X-axis direction is described as an example, and the present disclosure is not limited to such an aspect. For example, the liquid ejecting apparatus 100 may have a line method liquid ejecting apparatus in which the plurality of nozzles N are distributed over an entire width of the medium PP. As described above, also in the present modification example, the same effect as the effect of the embodiment and modification example described above can be obtained.

### Seventh Modification Example

The liquid ejecting apparatus 100 described in the embodiment and the modification example described above can be adopted in various devices such as a facsimile machine and a copying machine, in addition to a device dedicated to printing. Moreover, the application of the liquid ejecting apparatus of the present disclosure is not limited to printing. For example, a liquid ejecting apparatus that ejects a solution of a coloring material is used as a manufacturing apparatus that forms a color filter of a liquid crystal display device. In addition, a liquid ejecting apparatus that ejects a solution of a conductive material is used as a manufacturing apparatus that forms a wire or an electrode of a wiring substrate. As described above, also in the present modification example, the same effect as the effect of the embodiment and modification example described above can be obtained.

### 3. Appendixes

From the embodiments described above, for example, the following configuration can be ascertained.

According to Aspect 1 that is a preferred aspect, there is provided a liquid ejecting apparatus including: a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element; and a control portion that executes first evaluation for evaluating an ejection stability of the liquid from the nozzle, in which in the first evaluation, the control portion causes the detection portion to detect the residual vibration caused by continuously executing ejection driving of driving the piezoelectric element with a drive signal for ejecting the liquid from the nozzle as first residual vibration, and evaluates the ejection stability of the liquid from the nozzle based on the first residual vibration detected by the detection portion.

With Aspect 1, the ejection stability of the liquid from the nozzle can be appropriately and easily evaluated, without requiring an external element such as an imaging environment.

In the liquid ejecting apparatus according to Aspect 2 that is a specific example of Aspect 1, in the first evaluation, the control portion evaluates the ejection stability of the liquid from the nozzle based on an amplitude of at least one peak among a plurality of peaks of the first residual vibration.

With Aspect 2, the ejection stability of the liquid from the nozzle can be appropriately and easily evaluated, without specifying a cycle and a phase of the first residual vibration.

In the liquid ejecting apparatus according to Aspect 3 that is a specific example of Aspect 2, in the first evaluation, when an amplitude of a first peak, which is first among the plurality of peaks of the first residual vibration, is more than a first threshold value, the control portion determines that the ejection of the liquid from the nozzle is unstable.

With Aspect 3 as well, the ejection stability of the liquid from the nozzle can be appropriately and easily evaluated.

In the liquid ejecting apparatus according to Aspect 4 that is a specific example of Aspect 3, in the first evaluation, when an amplitude of a second peak, which is second among the plurality of peaks of the first residual vibration, is more than a second threshold value, the control portion determines that the ejection of the liquid from the nozzle is unstable.

With Aspect 4, since the ejection stability is evaluated based on the plurality of peaks of the first residual vibration, the ejection stability can be evaluated with high accuracy.

In the liquid ejecting apparatus according to Aspect 5 that is a specific example of Aspect 4, in the first evaluation, when the amplitude of the first peak is equal to or less than the first threshold value and the amplitude of the second peak is equal to or less than the second threshold value, the control portion determines that the ejection of the liquid from the nozzle is stable.

With Aspect 5 as well, the ejection stability can be evaluated with high accuracy.

In the liquid ejecting apparatus according to Aspect 6 that is a specific example of any one of Aspects 3 to 5, the control portion causes the detection portion to detect the residual vibration caused by executing the ejection driving only one time as second residual vibration, and uses a value based on an amplitude of a third peak, which is first among a plurality of peaks of the second residual vibration, as the first threshold value.

With Aspect 6, the ejection stability can be accurately evaluated, in accordance with a use condition of the liquid ejecting head.

In the liquid ejecting apparatus according to Aspect 7 that is a specific example of Aspect 4 or 5, the control portion causes the detection portion to detect the residual vibration caused by executing the ejection driving only one time as second residual vibration, uses a value obtained by multiplying an amplitude of a third peak, which is first among a plurality of peaks of the second residual vibration, by a first coefficient, as the first threshold value, and uses a value obtained by multiplying an amplitude of a fourth peak, which is second among the plurality of peaks of the second residual vibration, by a second coefficient less than the first coefficient, as the second threshold value.

With Aspect 7 as well, the ejection stability can be accurately evaluated, in accordance with the use condition of the liquid ejecting head. Further, with Aspect 7, the ejection stability can be evaluated with higher accuracy, as compared with a case where the ejection stability is evaluated based on only the amplitude of the first peak, which is first of the first residual vibration.

In the liquid ejecting apparatus according to Aspect 8 that is a specific example of any one of Aspects 1 to 7, the control portion causes the detection portion to detect the residual vibration caused by executing the ejection driving only one time as second residual vibration, and further executes second evaluation for evaluating an ejection state of the nozzle based on the second residual vibration detected by the detection portion.

With Aspect 8, the ejection state of the nozzle can be appropriately and easily evaluated by using the second residual vibration.

In the liquid ejecting apparatus according to Aspect 9 that is a specific example of any one of Aspects 1 to 8, the control portion executes the first evaluation for each of a plurality of drive signal candidates having different waveforms for ejecting the liquid from the nozzle, by using one drive signal candidate among the plurality of drive signal candidates as the drive signal, and specifies a drive signal candidate with which the ejection of the liquid from the nozzle is stable and a drive signal candidate with which the ejection of the liquid from the nozzle is unstable, from the plurality of drive signal candidates.

With Aspect 9, the waveform of the drive signal for driving the piezoelectric element can be appropriately and easily determined by determining the waveform of the drive signal candidate with which the ejection of the liquid from the nozzle is stable as the waveform of the drive signal.

In the liquid ejecting apparatus according to Aspect 10 that is a specific example of any one of Aspects 1 to 9, in the first evaluation, the control portion causes the detection portion to detect the residual vibration caused by continuously executing the ejection driving 10 times or more as the first residual vibration.

With Aspect 10 as well, the ejection stability of the liquid from the nozzle can be appropriately and easily evaluated.

According to Aspect 11 that is another preferred aspect, there is provided a liquid ejecting apparatus including: a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element; and a control portion, in which the control portion causes the detection portion to detect the residual vibration caused by repeating ejection driving of driving the piezoelectric element a plurality of times with a drive signal for ejecting the liquid from the nozzle as first residual vibration, and determines a waveform of the drive signal based on the first residual vibration detected by the detection portion.

With Aspect 11, the waveform of the drive signal for driving the piezoelectric element can be appropriately and easily determined.

According to Aspect 12 that is still another preferred aspect, there is provided a control method for a liquid ejecting apparatus including a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element, the method including: causing the detection portion to detect the residual vibration caused by repeating ejection driving of driving the piezoelectric element a plurality of times with a drive signal for ejecting the liquid from the nozzle as first residual vibration; and evaluating an ejection stability of the liquid from the nozzle based on the first residual vibration detected by the detection portion.

With Aspect 12, the ejection stability of the liquid from the nozzle can be

appropriately and easily evaluated, without requiring an external element such as an imaging environment.

According to Aspect 13 that is still another preferred aspect, there is provided a control method for a liquid ejecting apparatus including a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element, the method including: causing the detection portion to detect the residual vibration caused by repeating ejection driving of driving the piezoelectric element a plurality of times with a drive signal for ejecting the liquid from the nozzle as first residual vibration; and determining a waveform of the drive signal based on the first residual vibration detected by the detection portion.

With Aspect 13, the waveform of the drive signal for driving the piezoelectric element can be appropriately and easily determined.

What is claimed is:

1. A liquid ejecting apparatus comprising:
a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element; and
a control portion that executes first evaluation for evaluating an ejection stability of the liquid from the nozzle, wherein
in the first evaluation, the control portion causes the detection portion to detect the residual vibration caused by continuously executing ejection driving of driving the piezoelectric element with a drive signal for ejecting the liquid from the nozzle as first residual vibration, and evaluates the ejection stability of the liquid from the nozzle based on the first residual vibration detected by the detection portion.

2. The liquid ejecting apparatus according to claim 1, wherein
in the first evaluation, the control portion evaluates the ejection stability of the liquid from the nozzle based on an amplitude of at least one peak among a plurality of peaks of the first residual vibration.

3. The liquid ejecting apparatus according to claim 2, wherein
in the first evaluation, when an amplitude of a first peak, which is first among the plurality of peaks of the first residual vibration, is more than a first threshold value, the control portion determines that the ejection of the liquid from the nozzle is unstable.

4. The liquid ejecting apparatus according to claim 3, wherein
in the first evaluation, when an amplitude of a second peak, which is second among the plurality of peaks of the first residual vibration, is more than a second threshold value, the control portion determines that the ejection of the liquid from the nozzle is unstable.

5. The liquid ejecting apparatus according to claim 4, wherein
in the first evaluation, when the amplitude of the first peak is equal to or less than the first threshold value and the amplitude of the second peak is equal to or less than the second threshold value, the control portion determines that the ejection of the liquid from the nozzle is stable.

6. The liquid ejecting apparatus according to claim 3, wherein
the control portion
causes the detection portion to detect the residual vibration caused by executing the ejection driving only one time as second residual vibration, and
uses a value based on an amplitude of a third peak, which is first among a plurality of peaks of the second residual vibration, as the first threshold value.

7. The liquid ejecting apparatus according to claim 4, wherein
the control portion
causes the detection portion to detect the residual vibration caused by executing the ejection driving only one time as second residual vibration,
uses a value obtained by multiplying an amplitude of a third peak, which is first among a plurality of peaks of the second residual vibration, by a first coefficient, as the first threshold value, and
uses a value obtained by multiplying an amplitude of a fourth peak, which is second among the plurality of peaks of the second residual vibration, by a second coefficient less than the first coefficient, as the second threshold value.

8. The liquid ejecting apparatus according to claim 1, wherein
the control portion causes the detection portion to detect the residual vibration caused by executing the ejection driving only one time as second residual vibration, and further executes second evaluation for evaluating an ejection state of the nozzle based on the second residual vibration detected by the detection portion.

9. The liquid ejecting apparatus according to claim 1, wherein
the control portion
executes the first evaluation for each of a plurality of drive signal candidates having different waveforms for ejecting the liquid from the nozzle, by using one drive signal candidate among the plurality of drive signal candidates as the drive signal, and
specifies a drive signal candidate with which the ejection of the liquid from the nozzle is stable and a drive signal candidate with which the ejection of the liquid from the nozzle is unstable, from the plurality of drive signal candidates.

10. The liquid ejecting apparatus according to claim 1, wherein
in the first evaluation, the control portion causes the detection portion to detect the residual vibration caused by continuously executing the ejection driving 10 times or more as the first residual vibration.

11. A liquid ejecting apparatus comprising:
a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element; and
a control portion, wherein
the control portion
causes the detection portion to detect the residual vibration caused by repeating ejection driving of driving the piezoelectric element a plurality of times with a drive signal for ejecting the liquid from the nozzle as first residual vibration, and
determines a waveform of the drive signal based on the first residual vibration detected by the detection portion.

12. A control method for a liquid ejecting apparatus including a liquid ejecting head that includes a nozzle which ejects a liquid, a piezoelectric element which corresponds to the nozzle, a diaphragm which vibrates by driving the piezoelectric element, and a detection portion which detects residual vibration of the diaphragm caused by driving the piezoelectric element, the method comprising:
causing the detection portion to detect the residual vibration caused by repeating ejection driving of driving the piezoelectric element a plurality of times with a drive signal for ejecting the liquid from the nozzle as first residual vibration; and
evaluating an ejection stability of the liquid from the nozzle based on the first residual vibration detected by the detection portion.
